(19) United States
(12) Patent Application Publication
(10) Pub. No.: US 2026/0161007 A1
(43) Pub. Date: Jun. 11, 2026

(54) OPTICAL COMPONENT LASER WELDED TO PEDESTAL

(71) Applicant: Intuitive Surgical Operations, Inc., Sunnyvale, CA (US)

(72) Inventors: Mudabbir Badar, Christiansburg, VA (US); Mark E. Froggatt, Blacksburg, VA (US); Eric E. Sanborn, Blacksburg, VA (US)

(21) Appl. No.: 19/150,142

(22) PCT Filed: Jan. 11, 2024
(86) PCT No.: PCT/US2024/011284

§ 371 Date: Jul. 22, 2025

Related U.S. Application Data
(60) Provisional application No. 63/440,632, filed on Jan. 23, 2023.

(51) Int. Cl. G02B 27/62; B23K 26/0622; B23K 26/324; B23K 103/00; B23K 103/18

(52) U.S. Cl. CPC G02B 27/62; B23K 26/0624; B23K 26/324; B23K 2103/18; B23K 2103/52; B23K 2103/54

(57) ABSTRACT

An optical assembly can include a pedestal attached to a substrate and a first optical component laser welded to the pedestal. In some examples, a. bond between the first optical component and the pedestal can be formed from material of at least one of the first optical component and the pedestal melted via later welding. In some examples, the first optical component can be positioned to receive light from a second optical component, attached with the substrate, or transmit light to the second optical component. In some examples, a pedestal can include a first pedestal surface that is attached to the substrate and a second pedestal surface, angled with respect to the first pedestal surface, that is attached to an optical component. In some examples, a pedestal can include a first pedestal element attached to a second pedestal element, such as by laser welding.

### CROSS-REFERENCE TO RELATED APPLICATION

This application claims the benefit of U.S. Provisional Application No. 63/440,632, filed Jan. 23, 2023, which is hereby incorporated by reference in its entirety.

### FIELD OF THE DISCLOSE

The present disclosure relates generally to assembling components of an optical system, such as by laser welding.

### BACKGROUND OF THE DISCLOSURE

Optical components of various types may be combined to form optical systems that process light. The behavior of light that propagates through an optical system depends not only the types of optical components which the light encounters within the optical system, but also the relative positions and orientations of the optical components. Manufacturing such optical systems typically includes positioning and bonding of these optical components according to a specified design.

### SUMMARY

In an example, an optical assembly can comprise: a substrate; a first pedestal attached to the substrate, a first optical component laser welded to the first pedestal; and a second optical component attached with the substrate, the first optical component being positioned to receive light from the second optical component or transmit light to the second optical component.

In an example, an optical assembly can comprise: a substrate; a pedestal attached to the substrate; and an optical component laser welded to the pedestal, a bond between the optical component and the pedestal being formed from material of at least one of the optical component and the pedestal melted via later welding.

In an example, a method for generating an optical assembly can comprise: attaching a pedestal to a substrate; and laser welding a first optical component to the pedestal using an ultra-fast laser, the first optical component being spaced apart from the substrate, the pedestal and the first optical component being positioned such that the first optical component receives light from a second optical component attached with the substrate or transmits light to the second optical component.

### BRIEF DESCRIPTION OF THE DRAWINGS

FIG. 1 shows a perspective view of an example of a laser welding system.

FIG. 2 shows a side view of an example of an optical assembly.

FIG. 3 shows a side view drawing of an example of an optical assembly in which an optical component is positionable with three degrees of freedom with respect to a substrate.

FIG. 4 shows a side view drawing of an example of an optical assembly in which the optical component is positionable with five degrees of freedom with respect to the substrate.

FIG. 5 shows a side view drawing of another example of an optical assembly in which the optical component is positionable with five degrees of freedom with respect to the substrate.

FIG. 6 shows a side view drawing of another example of an optical assembly in which the optical component is positionable with five degrees of freedom with respect to the substrate.

FIG. 7 shows a side view drawing of another example of an optical assembly in which the optical component is positionable with five degrees of freedom with respect to the substrate.

FIG. 8 shows a side view drawing of another example of an optical assembly in which the optical component is positionable with five degrees of freedom with respect to the substrate.

FIG. 9 shows a side view drawing of another example of an optical assembly in which the optical component is positionable with five degrees of freedom with respect to the substrate.

FIG. 10 shows a side view drawing of another example of an optical assembly in which the optical component is positionable with five degrees of freedom with respect to the substrate.

FIG. 11 shows a side view drawing of an example of an optical assembly in which the optical component is positionable with six degrees of freedom with respect to the substrate.

FIG. 12 shows a side view drawing of an example of an optical assembly in which the optical component is positionable with six degrees of freedom with respect to the substrate.

FIG. 13 shows a side view drawing of the optical assembly of FIG. 12, in a view that is orthogonal to that of FIG. 12, with laser welding optics that show how several of the laser welds are formed.

FIG. 14 shows a side view drawing of another example of an optical assembly, with laser welding optics that show how several of the laser welds are formed.

FIG. 15 shows a schematic drawing of an example of an apparatus that includes a system for directing light into an optical fiber.

FIG. 16 shows a perspective view of an example of an optical assembly.

FIG. 17 shows a top view of the optical assembly of FIG. 16.

FIG. 18 shows a side view of the optical assembly of FIG. 16.

FIG. 19 shows a flow chart of an example of a method for generating an optical assembly.

Corresponding reference characters indicate corresponding parts throughout the several views. Elements in the drawings are not necessarily drawn to scale. The configurations shown in the drawings are merely examples and should not be construed as limiting in any manner.

### DETAILED DESCRIPTION

Embodiments relate to optical assemblies formed using components that are attached via laser welding. The components may include optical components of an optical system that process light. The components may also include other structures that facilitate the positioning of the optical components, such as substrates that provide a mounting base and pedestals that facilitate attachment of optical components with the substrate at multiple positional and/or orientational degrees of freedom.

Various bonding techniques can be used to assemble optical systems, such as by using attachment materials between components. For example, adhesives such as ultraviolet curable resins or thermally curable resins (e.g., cured via laser or other light) may be used to attach some or all of the components to each other. However, an adhesive may have a relatively high coefficient of thermal expansion (CTE), and this may require active thermal control. As another example, an adhesive can be formed from a hydroscopic material, so that the adhesive can absorb moisture over time. The absorbed moisture can change a dimension and strength of the adhesive. The absorbed moisture can change one or more properties of the adhesive material over time, which can degrade the adhesive strength. As another example, adhering two components together with suitable placement and adhesion tolerances may require a relatively thin bond line and may require active thermal control of the components.

In another examples, optical contacting can be used to attach some or all of the components to each other. Optical contacting relies on the van der Waals force to form a stable contact between two contacting (e.g., glass) surfaces. However, optical contacting can require that the surfaces be clean, such as free from particles or debris. As another example, optical contacting can require that the surfaces be relatively smooth, such as having a surface roughness of less than 2 nm. As another example, optical contacting can require that the surfaces be relatively flat, such as having a surface flatness less than 125 nm. As another example, optical contacting can produce a bond between the surfaces that can be weaker than bonds obtained by other adhesion techniques.

In another example, mechanical mounting and soldering can be used to attach some or all of the components to each other. However, mechanical mounting and soldering may not be suitable for adhering materials that have different coefficients of thermal expansion. In another example, anodic bonding can be used to attach some or all of the components to each other. However, anodic bonding can require numerous fabrication steps and may require a clean room environment. In another example, methods based on thermal diffusion and CO₂ laser joining can be used to attach some or all of the components to each other. However, these methods can be slow, such as by requiring several hours of thermal treatments of the components.

Welding two components via laser welding, such as by using an ultra-short pulse (UPS) laser, can overcome potential drawbacks of other attachment mechanisms, such as weak bonds, aging, slow processing, high cost, relatively tight tolerances on flatness and cleanliness of the surfaces of the components. Laser welding can avoid use of additional material that may be hydroscopic, use of additional material that may have a relatively high coefficient of thermal expansion, or use of a material that may be absorptive. Laser welding can optionally be used in combination with any other attachment mechanism.

In laser welding of components, optical elements can focus the pulsed laser to a relatively small area at an interface between the adjacent surfaces of the components. The laser welding may utilize an ultra-fast pulse laser (also referred to as an ultrashort pulse laser) beam focused at a very small area. With each pulse (e.g., generally on the order of femtoseconds to one picosecond), the laser pulse generates some heat due to absorption. The laser may have a relatively high repetition rate, which can allow heat to accumulate locally (e.g., before the heat can dissipate). The heat may accumulate enough to raise the temperature high enough to melt the (e.g., glass) components locally. After the pulsed laser has been applied, the melted material can cool and solidify, thereby forming a bond between the adjacent surfaces of components. This type of laser welding is also referred to herein as “direct” laser welding because the laser is used to weld surfaces of adjacent components without using an adhesive (e.g., that is cured by laser or other light) or other type of separate attachment material. The optical elements can translate the focus of the laser along the interface between the adjacent optical elements to form a bond over a larger surface area, such as in corners of a surface, around a perimeter of the surface, or at discrete locations that are distributed over a surface area of the surface. Away from the interface, such as in an interior of the components or outside the components, the instantaneous power of the pulsed laser is low enough to avoid melting of the components, or damaging any other components, such as electronic components or organic materials.

Laser welding can produce bonds including a visible artifact at the interface of the welded components. For example, a laser weld can appear as a ripple in the material at the three-dimensional location of the weld. Such an artifact can be readily observed with a microscope or other suitable imaging equipment. In some examples, the weld or welds can be located away from an operational area of the optical component.

Embodiments discussed herein relate to configurations and geometries of optical assemblies that can allow optical components to be positioned in space with multiple positional and orientational degrees of freedom, while allowing the optical components to be in contact with adjacent components (e.g., pedestals) that facilitate positioning of the optical components in a manner that is suitable for laser welding. Examples of suitable optical components can include lenses, objective elements, actuatable optical elements, windows, mirrors, dichroic mirrors, focusing elements, filters, beam splitters, sensors, V-groove fiber arrays, photonic integrated circuits (PIC), planar integrated circuits (PLC), and others. In the figures that follow, some of the optical components are depicted as being rectangular or having a rectangular cross section or a rectangular perimeter; it will be understood that any other suitable shapes can also be used.

In some examples, a pedestal that holds the optical component to the substrate may be used to direct a laser beam through the pedestal to laser weld components to each other (e.g., the optical component to the pedestal, pedestal elements of a pedestal to each other, or the pedestal to the substrate). In other examples, a temporary reflector that is not an attached component of the optical assembly may be used to direct a laser beam to laser weld adjacent components. The laser beam may be reflected by the reflector when passed through the reflector (e.g., using total internal reflection (TIR) of the laser beam within a prism) or may be reflected by the reflector (e.g., a mirror) without being passed through the reflector.

To form the laser weld, additional optical components (not shown) can direct a pulsed laser beam through a specified thickness of material to a focus at an interface between two contacting surfaces of the components.

In the following discussion, for simplicity, the substrate has a fixed position with respect to a coordinate system {x, y, z}, while other components, such as pedestals and optical components, are positioned with respect to the substrate and the coordinate system.

In the following discussion, for simplicity, various portions of various components are referred to as surfaces. A surface of a component, as discussed below, can be in contact with and/or bonded to a surface of another component. It will be understood that the surface at which contact and/or bonding occurs may be only a portion of a side of a component. In some examples, a surface may be entirely flat. In other examples, a surface may include curves or other non-flat features.

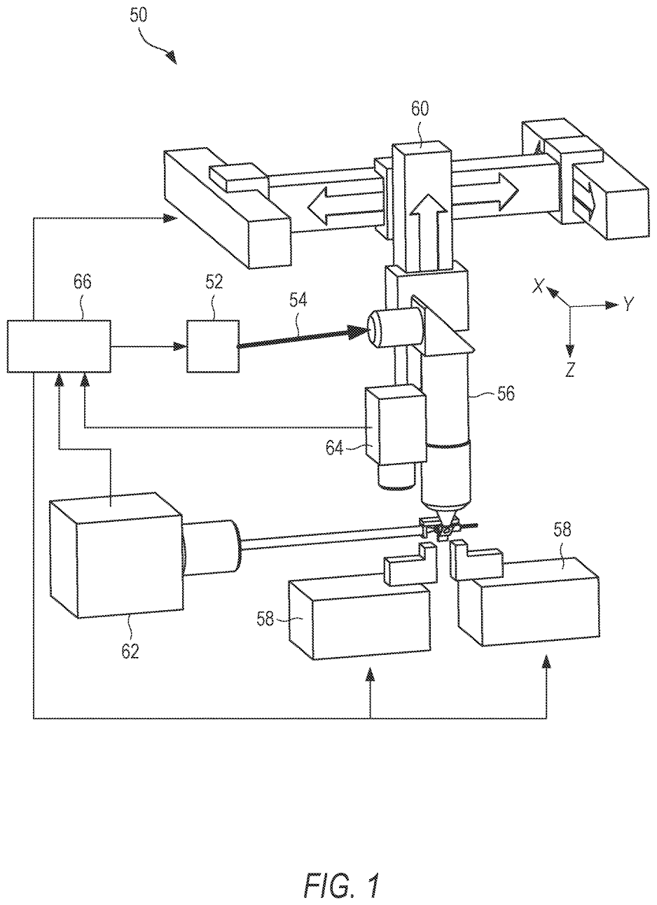

FIG. 1 shows a perspective view of an example of a laser welding system 50. The laser welding system 50 is but one example of a laser welding system; other laser welding systems can also be used.

The laser welding system 50 can include a laser light source 52. The laser light source 52 can produce a high-energy beam of laser light (“laser beam 54” 54) that is used to produce laser welds between adjacent surfaces in an optical assembly. In some examples, the laser light source 52 can be an ultrafast pulsed laser light source. The laser light source 52 can be a CO₂ laser, a neodymium-doped yttrium aluminum garnet (Nd:YAG) laser, a fiber laser, a semiconductor laser, or another suitable laser.

The laser welding system 50 can include beam focusing optics 56. The beam focusing optics 56 can guide the laser beam 54 from the laser light source 52 to the point of welding. The beam focusing optics 56 can include mirrors, lenses, and other optical components to focus and direct the laser beam 54. For example, the beam focusing optics 56 can include an objective lens that brings the laser beam 54 to a sharp focus at a specified location in space. As another example, the beam focusing optics 56 can include a turning mirror that can direct the laser beam 54 from the laser light source 52 to the objective lens. The beam focusing optics 56 can be enclosed, or may include light baffles, to block stray light from the laser beam 54 for the safety of operators and others in proximity to the laser welding system 50.

The laser welding system 50 can include a part positioner 58. The pail positioner 58 can hold the materials (e.g., components) being welded in place during the welding process. The part positioner 58 can include one or more fixtures, clamps, or robotic arms. The part positioner 58 can move an optical assembly to position the optical assembly with respect to the sharp focus of the laser beam 54. The part positioner 58 can perform its positioning with six degrees of freedom, including: position along an x-axis, position along ay-axis, position along a z-axis, rotation about the x-axis, rotation about the Y-axis, and rotation about the z-axis.

The laser welding system 50 can include a welding beam positioner 60. The welding beam positioner 60 can reposition the laser beam 54. In some examples, the welding beam positioner 60 can reposition the laser beam 54 with three degrees of freedom, including: position along the x-axis, position along the y-axis, and position along the z-axis.

The laser welding system 50 can include a alignment camera 62. The alignment camera 62 can provide for optical beam alignment, such as to facilitate checking of beam collimation, beam size and position of beam (in x- and y-axes) to align the beam with an optical axis of the beam focusing optics 56. The alignment camera 62 can generate image data of the optical beam and/or materials to be welded. The alignment camera 62 can capture a video image of the materials being welded in real time, or near-real time. In some examples, the alignment camera 62 can generate part position data that corresponds to a location of the materials being welded. In some examples, the alignment camera 62 can be used to visualize the far field beam formed by the optics to be weld together. For example, when welding together a device that collimates light then the alignment camera 62 can be used to confirm that the beam is collimated and pointed in the correct direction relative to features on the parts being made.

The laser welding system 50 can include a position sensor 64. The position sensor 64 can measure (directly or indirectly) positions in the z-direction of the materials being welded, with respect to the beam focusing optics 56. The position sensor 64 can generate position data that corresponds to the position in the x, y, or z-directions of the materials being welded, with respect to the beam focusing optics 56. The position sensor 64 can include a camera, a time-of-flight sensor that measures a round-trip time of light from the position sensor 64 to a reflecting element on the part positioner 58 and back to the position sensor 64, or other suitable measuring technique. The position sensor 64 can be used to confirm parts are in the correct location as well as confirm proper contact between surfaces prior to welding.

The laser welding system 50 can include a controller 66. The controller 66 can receive the data from the alignment camera 62 and the position sensor 64. The controller 66 can control at least one of the laser light source 52, the part positioner 58, and the welding beam positioner 60 in response to the received data.

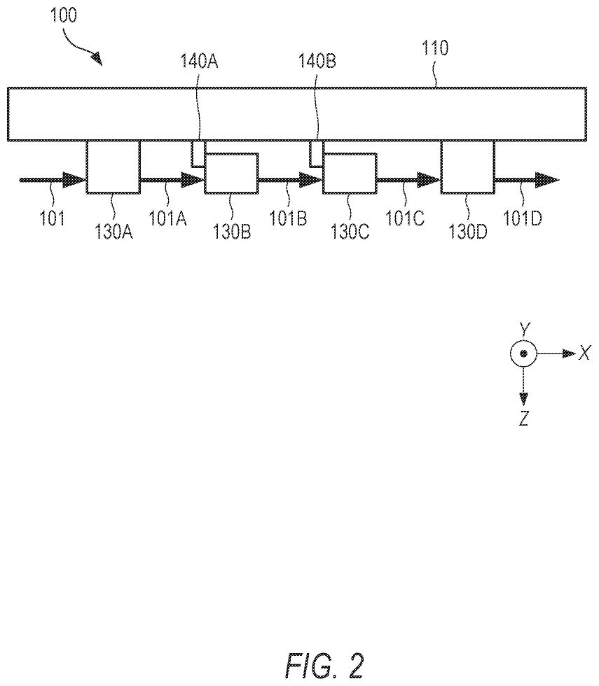

FIG. 2 shows a side view of an example of an optical assembly 100. The optical assembly 100 can include a substrate 110. The optical assembly 100 can include optical components that can receive light and/or transmit light to other optical components.

The optical assembly 100 can include a first optical component 130A attached to the substrate 110 (i.e., attached directly to the substrate 110, such as with no intervening components between the second optical component 130B and the substrate 110), such as by laser welding or another suitable attachment technique. In the example of FIG. 2, the first optical component 130A is positioned to receive a light beam 101, transmit at least some of the incident light 101 as light beam 101A.

The optical assembly 100 can include a second optical component 130B attached with the substrate 110 (i.e., attached directly to the substrate 110 or attached via some other component to the substrate 110), such as by laser welding or another suitable attachment technique. In the example of FIG. 2, the second optical component 130B is attached to a first pedestal 140A that is attached to the substrate 110. The second optical component 130B is positioned to receive the light beam 101A and transmit at least some of the light beam 101A as light beam 101B.

The first pedestal 140A may be attached to the substrate 110 by laser welding or another suitable attachment technique. The first pedestal 140A may provide one or more additional degrees of freedom when positioning the second optical component 130B during assembly of the optical assembly 100. For example, the first pedestal 140A provides for position adjustment along the Z-axis for the second optical component 13011 to ensure that light from the first optical component 130A is directed to the second optical component 130B. In another example, the first pedestal 140A may provide for a rotational adjustment in the x-Y plane for the second optical component 130B. The first pedestal 140A may also provide for a thicker mounting surface for attaching the second optical component 1301B to the substrate 110, such as when the second optical component is too thin for effective direct attachment to the substrate 110. In some examples, during use of the optical assembly 100, no light may pass through the first pedestal 140A. In other words, the first pedestal 140A may help position the second optical component 130B during assembly of the optical assembly 100 but may not provide any optical functions during use of the completed optical assembly 100. In other examples, the first pedestal 140A may provide one or more additional optical functions during use of the completed optical assembly 100 or may pass light without altering or substantially altering the light. The second optical component 130B can be laser welded to the first pedestal 140A. Other suitable attachment techniques may be used. As a result of being attached with the substrate 110 via the first pedestal 140A, the second optical component 130B can be spaced apart from the substrate 110 (e.g., along the z-axis), or otherwise aligned.

The optical assembly 100 can include a third optical component 130C attached with the substrate, such as by laser welding or another suitable attachment technique. In the example of FIG. 2, the third optical component 130C is positioned to receive the light beam 101B and transmit at least some of the light beam 101B as light beam 101C.

The optical assembly 100 can include a second pedestal 140B that is attached to the substrate 110, such as by laser welding or another suitable attachment technique. The second pedestal 140B may provide one or more additional degrees of freedom when positioning the third optical component 130C during assembly of the optical assembly 100. In some examples, during use of the optical assembly 100, no light may pass through the second pedestal 140B. In other words, the second pedestal 140B may help position the third optical component 130C during assembly of the optical assembly 100, but may not provide any optical functions during use of the completed optical assembly 100. In other examples, the second pedestal 140B may provide one or more additional optical functions during use of the completed optical assembly 100 or may pass light without altering or substantially altering the light. The third optical component 130C can be laser welded to the second pedestal 140B. Other suitable attachment techniques may be used. The third optical component 130C can be spaced apart from the substrate 110. Furthermore, the second pedestal 140B provides for position adjustment along the z-axis for the third optical component 130C to ensure that light from the second component 130B is directed to the third optical component 130C, rotational alignment along in the x-y plane, or otherwise facilitate proper alignment for the third optical component 130C.

The optical assembly 100 can include a fourth optical component 130D attached to the substrate 110, such as by laser welding or another suitable attachment technique. In the example of FIG. 2, the fourth optical component 130D is positioned to receive the light beam 101C and transmit at least some of the light beam 101C as light beam 101D.

As discussed in greater detail below, the use of a pedestal, such as the first pedestal 140A or the second pedestal 140B, to mount an optical component, such as the second optical component 130B or the third optical component 130C, to the substrate 110 allows the optical component to be mounted with multiple (e.g., five) degrees of freedom. A pedestal may also facilitate proper physical attachment, such as when an optical component is too thin for direct attachment with the substrate 110. Multiple optical components may be positioned in this manner to form an optical system, such as the optical assembly 100. An optical assembly 100 may include one or more optical components that are mounted via a pedestal to the substate. Each optical component, which may or may not be mounted via a pedestal, is positioned to received light or transmit light from at least one other (e.g., adjacent) optical component.

The pedestal, such as the first pedestal 140A or the second pedestal 140B, may include different shapes, such as a wedge shape or a rectangular shape. A wedge-shaped pedestal can include a first pedestal surface that is attached to the substrate and a second pedestal surface, angled with respect to the first pedestal surface, that is attached to an optical component, such as the second optical component 130B or the third optical component 130C. In other examples, the optical component, such as the second optical component 130B or the third optical component 130C, is attached to a pedestal surface that is perpendicular to the first pedestal surface that is attached to the substrate. A wedge-shaped pedestal may be used to direct the laser beam used to weld the pedestal to the optical component.

A pedestal, such as the first pedestal 140A or the second pedestal 140B, may be formed from multiple pedestal elements that can be attached to each other at different orientations to provide an additional degree of freedom for positioning of an optical component, such as the second optical component 130B or the third optical component 130C. For example, a pedestal can include a first pedestal element attached to a second pedestal element, such as by laser welding. The first pedestal element can be laser welded to the substrate 110. The second pedestal element can be laser welded to an optical component, such as the second optical component 130B or the third optical component 130C. These configurations and others are described in detail below.

The components of the optical assembly 100 can include various types of materials. Components that are used to pass laser light for welding during manufacturing of the optical assembly 100 should include a material that is sufficiently transparent for the wavelength of the laser light, such as glass, crystal, or ceramic for laser light having a wavelength of about 1030 nm, although other wavelengths can be used, such as 780 nm. The optical components, which may or may not be used to pass laser light during manufacturing, should also be sufficiently transparent for light processed by the optical assembly, such as light having a wavelength of about 1030 nm or other suitable wavelength. An example of a suitable wavelength range can include the communication C band (“conventional” band), which includes wavelengths between 1530 nm and 1565 nm. In one example, the substrate, pedestal, and/or optical component may each include glass, crystal, or ceramic. Components that are not used to pass laser light for welding during the manufacturing of the optical assembly can include a material that is opaque for the wavelength of the laser light. For example, the pedestal may include a metal or other type of material having low coefficients of thermal expansion when laser light is not transmitted through the pedestal during manufacturing of the optical assembly. In some examples, such as when laser light is not transmitted through the optical component during manufacturing of the optical assembly, an optical component may include silicon (e.g., a silicon lens), which is opaque at the welding laser wavelength but not opaque for the light (e.g., which may also be laser light) processed by the optical assembly.

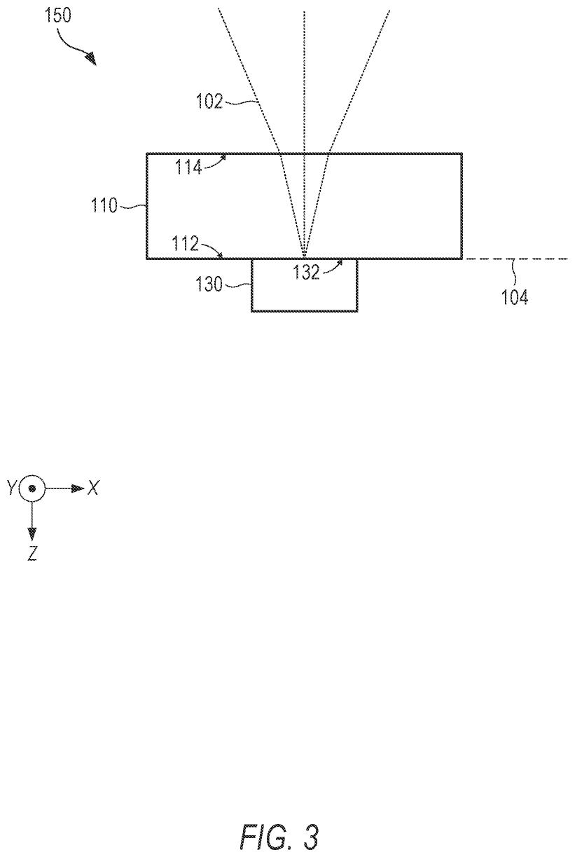

FIG. 3 shows a side view drawing of an example of an optical assembly 150 in which an optical component 130 is positionable with three degrees of freedom with respect to a substrate 110.

The optical assembly 150 includes the substrate 110. The substrate 110 can mechanically support other optical elements via attachment to the substrate 110. In some examples, the substrate 110 can be formed from a material that is transparent or substantially transparent at a wavelength of the pulsed laser. In some examples, the substrate 110 can be formed from a material that can be laser welded, such as by using the pulsed laser. The substrate 110 can have a (e.g., planar) surface 112, on which other optical components or optical elements can be attached, such as by laser welding. The substrate 110 can optionally include a second surface 114, opposite the surface 112 and substantially parallel to the surface 112. By using parallel surfaces, such as surface 112 and second surface 114, the substrate 110 can help avoid introducing aberrations into the laser beam 102 as it passes through the substrate 110. Such aberrations may distort the focused spot of the laser beam 102 and potentially degrade the laser weld quality.

The optical assembly 150 includes an optical component 130 that is directly attached to the substrate 110. To be compatible with laser welding, the optical component 130 can have a (e.g., planar) surface 132, which can contact the surface 112 of the substrate 110 along an interface 104. In the configuration of FIG. 3, the interface 104 extends in the x-Y plane. When the surface 132 is in contact with the surface 112, the laser beam 102 can be activated to form a laser weld between the surface 132 and the surface 112 to secure the optical component 130 to the substrate 110.

The laser welds can be formed by directing the pulsed laser light through the substrate 110 toward the interface 104. During manufacturing, the substrate 110 and optical component 130 may be placed as shown such that the laser light can be directed in a downwards direction to facilitate eye safety.

For some geometries, directing the laser light through the substrate 110 toward the interface 104 can help avoid distortion of the focused spot due to optical aberrations. Such distortion can be prevented or reduced if, for all interfaces between materials having different refractive indices (e.g., interfaces between glass and air) through which the laser beam 102 passes, the interfaces are orthogonal or substantially orthogonal to a central axis of the laser beam 102.

The optical component 130 can be one of a series of components that form an optical system on the substrate 110. The optical component 130 can direct light to one or more other components. The optical component 130 can receive light from one or more other components. For example, the optical system can include a lens that can collimate light from a light source, such as a tip of an optical fiber, to form a beam. The optical system can include a dichroic mirror to separate spectral components of the beam, such as by sending a first spectral portion of the beam in one direction and a second spectral portion of the beam in another direction. The optical system can include an actuatable optical component, such as a pivotable mirror, which can controllably reposition a downstream portion of the beam and can define an optical path for the light. The optical system can include a focusing element, which can form an image at a focal plane of the focusing element. The lens, dichroic mirror, pivotable mirror, and focusing element are examples of optical components 130. Other suitable optical components can also be used, such as optical fibers, polarizers, waveplates, filters, gain chips, gain rods, gratings, optical modulator crystals, and so forth. In some examples, light may be propagated through the optical components 130 of the optical assembly 150 in a direction that is generally parallel to the surface 112 of the substrate 110. Although not shown in FIG. 2, an optical component 130, such as a filter, may reflect a portion of the received light that is not transmitted through the optical component 130.

In some examples, alignment of the optical component 130 (e.g., with respect to an absolute position on the substrate or a relative position to one or more other optical components) can be performed in a closed-loop manner using feedback. For example, closed-loop alignment can include dithering a position of a collimating lens, sensing a position of a collimated beam downstream of the lens (such as by directing the collimated beam onto a split detector or other position sensor), and controlling the dither to center the beam on the split detector and thereby set the position of the lens. In some examples, the alignment can be performed in an open-loop manner, such as by moving the optical component 130 to a specified set of coordinates, without using explicit feedback. In some examples, the alignment can be performed by a combination of open-loop and closed-loop techniques.

Once the optical component 130 has been spatially aligned to achieve the specified orientation and the specified three-dimensional position with respect to the substrate 110, the optical component 130 can be laser welded into place, thereby securing the spatially aligned element to the specified orientation and specified three-dimensional position, with respect to an absolute position or a relative position with respect to other optical elements on or in the substrate 110.

Much of the following discussion is directed to geometries and configurations that improve the ability to align and secure in place the optical component 130.

In the configuration of FIG. 3, the surface 132 of the optical component 130 contacts the surface 112 of the substrate 110 along an interface 104 that extends in the x-y plane. During alignment of the optical component 130 to the substrate 110, the optical component 130 is translatable and rotatable in the plane of the interface 104. In the configuration of FIG. 3, the optical component 130 can be positioned with respect to the substrate 110 with three degrees of freedom. The three degrees of freedom include position along the X-axis (by translating the optical component 130 against the planar surface 112 of the substrate 110), position along the y-axis (also by translating the optical component 130 against the planar surface 112 of the substrate 110), and rotation about the z-axis (by rotating the optical component 130 on the planar surface 112 of the substrate 110).

Other configurations, discussed below in detail, can provide more than three degrees of freedom for aligning the optical component 130 to the substrate 110. For example, because the optical component 130 is attached directly to the substrate 110, it is not possible to change the position of the optical component 130 along the z-axis.

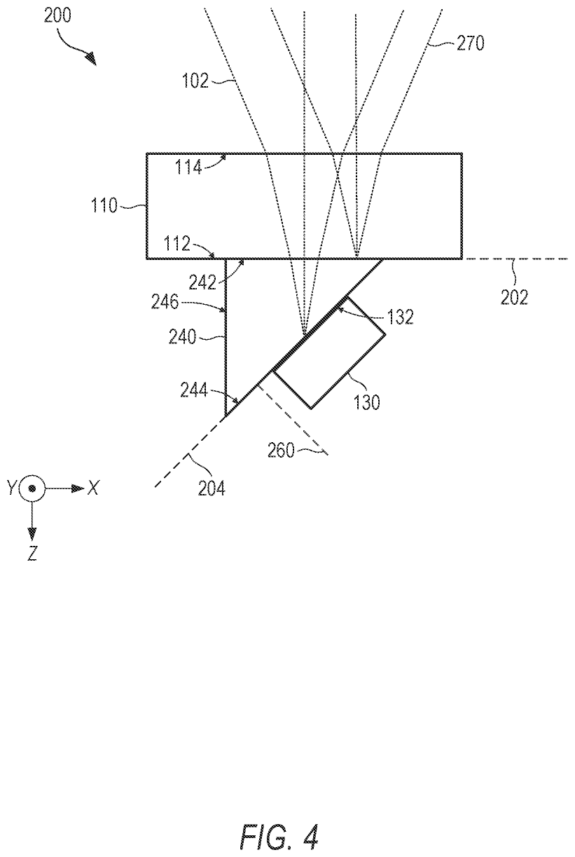

FIG. 4 shows a side view drawing of an example of an optical assembly 200 in which the optical component 130 is positionable with five degrees of freedom with respect to the substrate 110.

The optical assembly 200 includes the substrate 110, which is described in detail above.

The optical assembly 200 includes a pedestal 240 that includes a wedge shape. The pedestal 240 can be a prism. In some examples, the pedestal 240 can have the same refractive index as the substrate 110. In some examples, the pedestal 240 can be formed from the same material as the substrate 110. In some examples, the pedestal 240 can have a refractive index that is greater than that of the substrate 110. Using a pedestal 240 with a relatively high refractive index (e.g., relative to air and/or the substrate 110) can extend the focal length of a laser beam 102 used to perform laser welding of components.

The pedestal 240 can have a first (e.g., planar) surface 242 that faces the substrate 110 and contacts the surface 112 of the substrate 110 at a first interface 202 that extends in the x-Y plane. The pedestal 240 can have a second (e.g., planar) surface 244 that is angled non-orthogonally with respect to the first surface 242. In some examples, the second surface 244 can be angled at 45 degrees with respect to the first surface 242, although other suitable wedge angles can also be used. The pedestal 240 can optionally have a third planar wedge surface 246 that is orthogonal, or substantially orthogonal within typical manufacturing tolerances and alignment tolerances, to the first surface 242. In some examples, the pedestal 240 can have a triangular cross section, such as in the x-z plane of FIG. 4. In some examples, the pedestal 240 can have a right-triangular cross section, such as in the x-z plane of FIG. 4. In some examples, the pedestal 240 can have a triangular cross section, such as in the x-z plane of FIG. 4, that includes two 45-degree angles and a 90-degree angle. In some examples, the second surface 244 can form a hypotenuse of a triangular cross section of the pedestal 240.

The optical assembly 200 includes the optical component 130, which is described in detail above. In the configuration of FIG. 4, the surface 132 of the optical component 130 contacts the second surface 244 of the pedestal 240 along a second interface 204 that is angled with respect to the x-y plane.

During alignment of the optical component 130 to the substrate 110, the pedestal 240 and the optical component 130, together, are translatable and rotatable in the plane of the first interface 202. This provides for the three degrees of freedom including position along the x-axis (by translating the pedestal 240 against the surface 112 of the substrate 110), position along the y-axis (also by translating the pedestal 240 against the surface 112 of the substrate 110), and rotation about the z-axis (by rotating the pedestal 240 on the surface 112 of the substrate 110). During alignment of the optical component 130 to the substrate 110, the optical component 130 is translatable and rotatable in the plane of the second interface 204 with respect to the pedestal 240 to provide two additional degrees of freedom. In particular, the optical component 130 is translatable with respect to the pedestal 240 along the second interface 204 to provide for position adjustment along the z-axis, and rotatable on the pedestal 240 about an axis 260 defined orthogonal to the second interface 204.

As such, the optical component 130 can be positioned with respect to the substrate 110 with five degrees of freedom. The five degrees of freedom can include the position in the x-direction, position in they-direction, position in the z-direction, rotation about the z-direction (by rotating the pedestal 240 and the optical component 130, together, in the plane of the first interface 202), and rotation about the axis 260 that is orthogonal to the plane of the second interface 204.

When the pedestal 240 has been suitably positioned with respect to the substrate 110, the pedestal 240 can be affixed to the substrate 110, such as by forming a laser weld, with a laser beam 270, at the first interface 202 between the first surface 242 of the pedestal 240 and the surface 112 of the substrate 110. In some examples, the pedestal 240 can be attached to the substrate 110 by a mechanism other than laser welding, such as using an adhesive, optical contacting, or others.

Similarly, when the optical component 130 has been suitably positioned with respect to the substrate 110, the optical component 130 can be laser welded to the pedestal 240, such as by forming a laser weld at the second interface 204, with the laser beam 102, between the surface 132 of the optical component 130 and the second surface 244 of the pedestal 240.

When the optical component 130 has been attached to the pedestal 240, such as by laser welding, the optical component 130 is spaced apart from the substrate 110 along the z-axis. This allows for the control of relative heights of optical components when building an optical system.

In some examples, the pedestal 240 and optical component 130 are held in position on the substrate 110, such as by using robotic arms. After being held in place, the pedestal 240 is bonded to the substrate 110 and the optical component 130 is bonded to the pedestal. The order of the substrate-to-pedestal bonding process and the pedestal-to-optical component bonding process may vary. In one example, a single laser is used to sequentially perform the two bonding processes, such as by using optics in the laser welder to move laser beam 270 to form laser beam 102, or to move laser beam 102 to form laser beam 270. In other example, the two bonding processes may be performed in parallel using different lasers and/or laser beams. In some examples, the laser beam 270 used to bond the pedestal 240 to the substrate 110 may be passed through the substrate 110 from above to the interface 202.

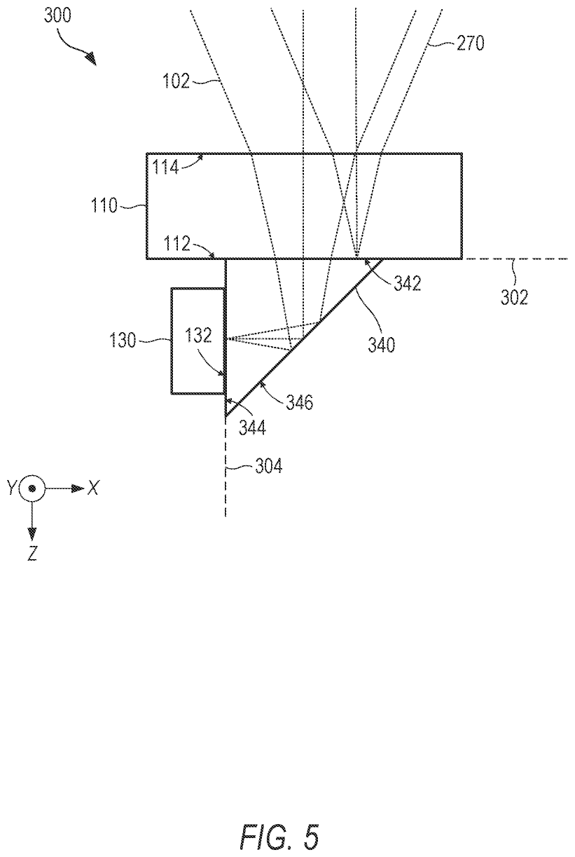

FIG. 5 shows a side view drawing of another example of an optical assembly 300 in which the optical component 130 is positionable with five degrees of freedom with respect to the substrate 110.

The optical assembly 300 includes the substrate 110, which is described in detail above.

The optical assembly 300 includes a pedestal 340 that includes a wedge shape. The pedestal 340 can perform at least two functions. First, the pedestal 340 can mechanically support the optical component 130, such as by having the optical component 130 welded to a surface of the pedestal 340. Second, the pedestal 340 can be used as a prism that receives the laser beam 102 from the substrate 110, reflects the laser beam 102 at a hypotenuse 346 of the pedestal 340, and directs the laser beam 102 toward the optical component 130. The directed laser beam 102 is focused along a second interface 304 between the optical component 130 to the pedestal 340 to weld the optical component 130 to the pedestal 340. The pedestal 340 can be a 45-45-90 prism in which a cross section of the pedestal 340 in the x-z plane has angles of 45 degrees, 45 degrees, and 90 degrees. Other suitable geometries can also be used, including some geometries in which an angular deflection of the laser beam 102 is 90 degrees or about 90 degrees. In some examples, the pedestal 340 can have the same refractive index as the substrate 110. In some examples, the pedestal 340 can be formed from the same material as the substrate 110. In some examples, the pedestal 340 can have a refractive index that is greater than the substrate 110. Using a pedestal 340 with a relatively high refractive index (e.g., relative to air and/or the substrate 110) can extend the focal length of the laser beam 102, helping to ensure that the laser beam 102 can reach the second interface 304 between the optical component 130 to the pedestal 340 to weld the optical component 130 to the pedestal 340.

The pedestal 340 can have a first (e.g., planar) surface 342 that faces the substrate 110 and contacts the surface 112 of the substrate 110 at a first interface 302 that extends in the x-y plane. The pedestal 340 has hypotenuse 346 that can be angled at 45 degrees (or about 45 degrees up to deviations within typical manufacturing tolerances) with respect to the first surface 342. The pedestal 340 can have a second (e.g., planar) surface 344 that is orthogonal (or substantially orthogonal within typical manufacturing tolerances) to the incident first surface 342.

For configurations in which the hypotenuse 346 is angled at 45 degrees with respect to the substrate, the laser beam 102 can reflect from the hypotenuse 346 to be redirected by 90 degrees, such that a central axis of the laser beam 102 is parallel, or substantially parallel, to the first surface 342 of the pedestal 340.

In some examples, the hypotenuse 346 of the pedestal 340 can be uncoated, so that the hypotenuse 346 includes a bare interface between air and the material of the pedestal 340. The laser beam 102 can reflect via total internal reflection at the hypotenuse 346. To achieve total internal reflection, an incident angle of light (formed with respect to a surface normal) at the hypotenuse 346 is greater than a critical angle. Because the laser beam 102 is a converging (e.g., non-collimated) beam at the hypotenuse 346, each portion of the beam that is to be reflected should reach the hypotenuse 346 at an incident angle greater than the critical angle. For a 45-45-90 pedestal 340 having a refractive index n and a converging laser beam 102 having a numerical aperture NA (equal to the sine of a half-angle of the convergent cone of light in the laser beam 102), the condition of total internal reflection can be met for any portions of the converging laser beam 102 when the condition of Equation (1) is met:

$$n > \sqrt{4 - 4 \sqrt{2} NA + 3 {NA}^{2}} \qquad ( 1 )$$

In some examples, the hypotenuse 346 of the pedestal 340 can be coated with a reflective material, such as a metal. For configurations in which the refractive index of the pedestal 340 does not meet the criteria for total internal reflection, the reflective material can increase a reflectivity at the hypotenuse 346. In some examples, the reflective material can help ensure that laser light does not leak out of the optical assembly 300 during the manufacturing process, which can ensure that sufficient laser energy reaches the welding location and/or help avoid (e.g., eye) damage that may be caused by leaked light.

The optical assembly 300 includes the optical component 130, which is described in detail above. In the configuration of FG. 5, the surface 132 of the optical component 130 contacts the second surface 344 of the pedestal 340 along the second interface 304 that extends in the y-z plane.

During alignment of the optical component 130 to the substrate 110, the pedestal 340 and the optical component 130, together, are translatable and rotatable in the plane of the first interface 302. This provides for the three degrees of freedom including position along the x-axis (by translating the pedestal 340 against the surface 112 of the substrate 110), position along the y-axis (also by translating the pedestal 340 against the surface 112 of the substrate 110), and rotation about the z-axis (by rotating the pedestal 340 on the surface 112 of the substrate 110). During alignment of the optical component 130 pedestal to the substrate 110, the optical component 130 is translatable and rotatable in the plane of the second interface 304 with respect to the pedestal 344 to provide two additional degrees of freedom. In particular, the optical component 130 is translatable with respect to the pedestal 340 along the second interface 304 to provide for position adjustment along the z-axis, and rotatable on the pedestal 340 about the x-axis defined orthogonal to the second interface 304.

As such, the optical component 130 can be positioned with respect to the substrate 110 with five degrees of freedom. The five degrees of freedom can include position in the x-direction, position in the y-direction, position in the z-direction, rotation about the z-direction (by rotating the pedestal 340 and the optical component 130, together, in the plane of the first interface 302), and rotation about the x-direction (by rotating the optical component 130 in the plane of the second interface 304).

When the optical component 130 has been suitably positioned with respect to the substrate 110, the pedestal 340 can be affixed to the substrate 110, such as by forming a laser weld, using the laser beam 270, at the first interface 302 between the first surface 342 of the pedestal 340 and the surface 112 of the substrate 110. In some examples, the pedestal 340 can be attached to the substrate 110 by a mechanism other than laser welding, such as using an adhesive, optical contacting, or others.

Similarly, when the optical component 130 has been suitably positioned with respect to the substrate 110, the optical component 130 can be laser welded to the pedestal 340, such as by forming a laser weld, using the laser beam 102, at the second interface 304 between the surface 132 of the optical component 130 and the second surface 344 of the pedestal 340.

In some examples, the pedestal 340 and optical component 130 are held in position on the substrate 110, such as by using robotic arms. After being held in place, the pedestal 340 is bonded to the substrate 110 and the optical component 130 is bonded to the pedestal. The order of the substrate-to-pedestal bonding process and the pedestal-to-optical component bonding process may vary. In one example, a single laser is used to sequentially perform the two bonding processes. In other example, the two bonding processes may be performed in parallel using different lasers and/or laser beams. In some examples, the laser beam used to bond the pedestal 340 to the substrate 110 may be passed through the substrate 110 from above to the interface 302.

When the optical component 130 has been attached to the pedestal 340, such as by laser welding, the optical component 130 is spaced apart from the substrate 110 along the z-axis. This allows for the control of relative heights of optical components when building an optical system. Different optical components may each be attached respective pedestals at different heights to achieve the desired alignment for light transmission.

Compared to the configuration of FIG. 4, the configuration of FIG. 5 can simplify a scanning process for the laser welder. Because the weld interface is not located along an inclined surface (as is the case for the weld being at the inclined second interface 204 in FIG. 4), the laser optics can scan the laser beam 102 in a plane that is orthogonal to the central axis of the laser beam 102 (e.g., parallel to the surface 112 of the substrate 110), thereby simplifying the scanning process. For example, the laser only needs to be moved along the x-y plane to focus the laser at different locations along the second interface 304, while the laser also needs to be moved along the Z-axis to focus the laser at different locations along the second interface 204.

Passing the laser beam 102 through the pedestal 340 may be used to extend the focal length of the laser beam 102. The amount of extension of the focal length can be varied based on the index of refraction of the material of the pedestal, with higher index of refraction correspond with longer focal lengths. In some examples, the laser beam 102 may not reach the second interface 304 if not passed through the pedestal 340. As such, an advantage of using a pedestal 340 or other different index of refraction (e.g., higher than air) material is to adjust the focal length of the laser beam used to perform the laser welding at interfaces between components.

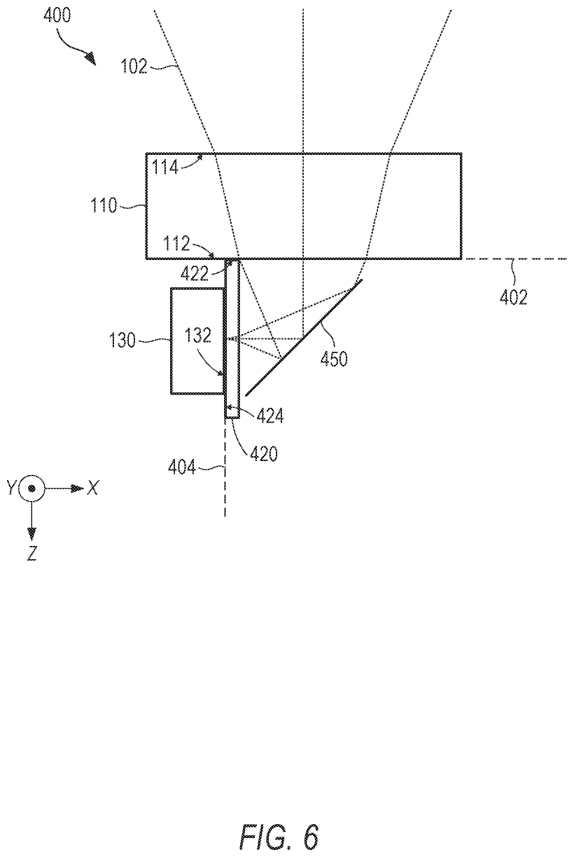

FIG. 6 shows a side view drawing of another example of an optical assembly 400 in which the optical component 130 is positionable with five degrees of freedom with respect to the substrate 110.

The optical assembly 400 includes the substrate 110, which is described in detail above.

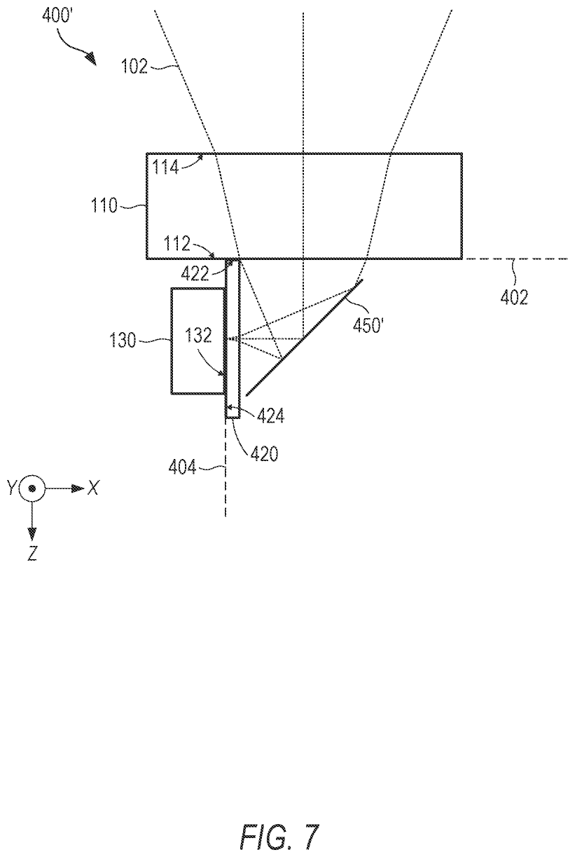

During assembly of the optical assembly 400, a reflector 450 can angularly deflect the laser beam 102 toward a second interface 404 between the optical component 130 and a pedestal 420. In one example, the reflector 450 angularly deflects the laser beam 102 by 90 degrees or about 90 degrees, such that a central axis of the laser beam 102 is parallel or substantially parallel to the surface 112 of the substrate 110. Other angles of deflection can also be used. The reflector 450 may not be part of the optical assembly 400, is not attached to the substrate 110, and may be removed after the optical component 130 is attached to the pedestal 420. FIGS. 7-9 show various configurations for the reflector 450. Other configurations are also possible.

The optical assembly 400 includes the pedestal 420, which can mechanically support the optical component 130 after the optical assembly 400 has been assembled. The pedestal 420 can be attached to the substrate 110, such as by laser welding or some other attachment mechanism. The pedestal 420 can have a first (e.g., planar) surface 422 that faces the substrate 110 and contacts the surface 112 of the substrate 110 at a first interface 402 that extends in the x-y plane. The pedestal 420 can have a second (e.g., planar) surface 424 that faces the optical component 130 and contacts the surface 132 of the optical component 130 at a second interface 404 that extends in the y-z plane. In some examples, the pedestal 420 can be shaped as a cuboid. In some examples, the pedestal 420 can lack optical coatings on its surfaces. In some examples, the pedestal 420 can include a thin-film dielectric antireflection coating on a surface opposite the second surface 424.

During alignment of the optical component 130 to the substrate 110, the pedestal 420 and the optical component 130, together, are translatable and rotatable in the plane of the first interface 402. This provides for the three degrees of freedom including position along the x-axis (by translating the pedestal 420 against the surface 112 of the substrate 110), position along they-axis (also by translating the pedestal 420 against the surface 112 of the substrate 110), and rotation about the z-axis (by rotating the pedestal 420 on the surface 112 of the substrate 110). During alignment of the optical component 130 to the substrate 110, the optical component 130 is translatable and rotatable in the plane of the second interface 404 with respect to the pedestal 420 to provide two additional degrees of freedom. In particular, the optical component 130 is translatable with respect to the pedestal 420 along the second interface 404 to provide for position adjustment along the z-axis, and rotatable on the pedestal 420 about the x-axis defined orthogonal to the second interface 404.

To laser weld the pedestal 420 to the substrate 110, the laser beam 102 can be directed to pass through the substrate 110 to form a laser weld at the first interface 402 between the first surface 422 of the pedestal 420 and the surface 112 of the substrate 110.

In the configuration of FIG. 6, the optical component 130 can be positioned with respect to the substrate 110 with five degrees of freedom. The five degrees of freedom can include position in the x-direction, position in the y-direction, position in the z-direction, rotation about the z-direction (by rotating the pedestal 420 and the optical component 130, together, in the plane of the first interface 402), and rotation about the x-direction (by rotating the optical component 130 in the plane of the second interface 404).

When the pedestal 420 has been suitably positioned with respect to the substrate 110, the pedestal 420 can be affixed to the substrate 110, such as by forming a laser weld at the first interface 402 between the first surface 422 of the pedestal 420 and the surface 112 of the substrate 110. In some examples, the pedestal 420 can be attached to the substrate 110 by a mechanism other than laser welding, such as using an adhesive, optical contacting, or others.

Similarly, when the optical component 130 has been suitably positioned with respect to the substrate 110, the optical component 130 can be laser welded to the pedestal 420, such as by forming a laser weld at the second interface 404 between the surface 132 of the optical component 130 and the second surface 424 of the pedestal 420.

When the optical component 130 has been attached to the pedestal 420, such as by laser welding, the optical component 130 is spaced apart from the substrate 110 along the z-axis.

In some examples, the pedestal 420 can be welded to the substrate 110 before the optical component 130 is welded to the pedestal 420. In some examples, the optical component 130 can be welded to the pedestal 420 before the pedestal 420 is welded to the substrate 110.

As explained above, the reflector 450 can be removed from the optical assembly 400 after the optical component 130 and the pedestal 420 have been welded to each other. The reflector 450 can be more expensive than the pedestal, for at least the following two reasons. First, the reflector 450 may include a highly reflective surface that includes a metal coating. Second, for configurations in which the reflector 450 is a prism, the prism may have relatively tight dimensional tolerances. The pedestal 420 lacks a reflective coating and lacks tight dimensional tolerances. Because the pedestal 420 can be part of the optical assembly 400 and the reflector 450 can be reused, the configuration of FIG. 6 can be less expensive than the configuration of FIG. 5. However, using the pedestal 340 of FIG. 5 obviates the need to use a separate reflector 450. This can simplify the manufacturing process because fewer components need to be held in place and a lower number of components are needed.

FIG. 7 shows a side view drawing of another example of an optical assembly 400′ in which the optical component 130 is positionable with five degrees of freedom with respect to the substrate 110. The optical assembly 400′ includes a reflector 450′ to angularly deflect the laser beam 102 toward a second interface 404 between the optical component 130 and the pedestal 420. In the example of FIG. 7, the reflector 450′ is a planar mirror. The planar mirror can be angled at 45 degrees with respect to the surface 112 of the substrate 110, or angled at another suitable angle. The planar mirror can have a reflective coating, such as a reflective metal layer.

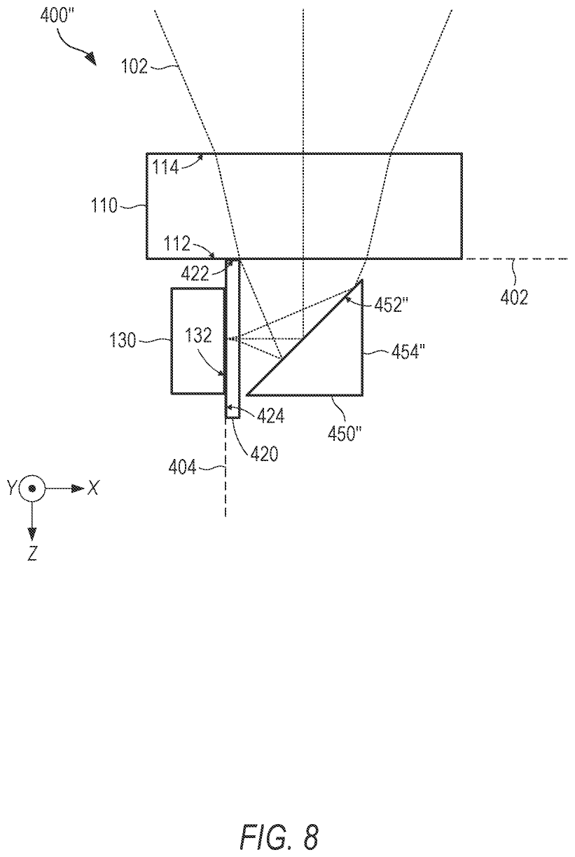

FIG. 8 shows a side view drawing of another example of an optical assembly 400″ in which the optical component 130 is positionable with five degrees of freedom with respect to the substrate 110. The optical assembly 400″ includes a reflector 450″ to angularly deflect the laser beam 102 toward a second interface 404 between the optical component 130 and the pedestal 420. In the example of FIG. 8, the reflector 450″ includes a reflective surface 452″ of a prism 454″, which can be oriented such that the laser beam 102 can remain outside of the prism 454″. The reflective surface 452″ of the prism 454″ can include a reflective coating, such as a reflective metal layer. In some examples, the reflective surface 452″ of the prism 454″ can include a hypotenuse of the prism 454″. Other surfaces of the prism 454″ can also be used.

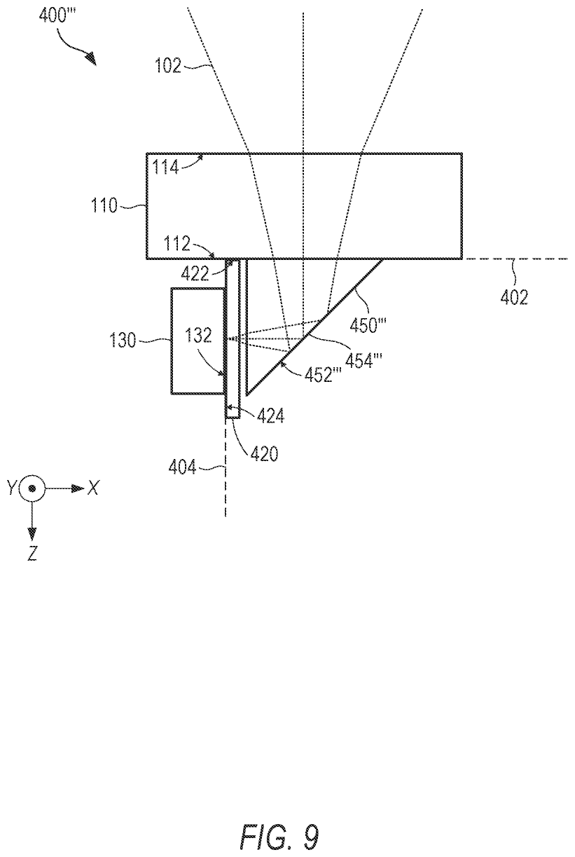

FIG. 9 shows a side view drawing of another example of an optical assembly 400′″ in which the optical component 130 is positionable with five degrees of freedom with respect to the substrate 110. The optical assembly 400′″ includes a reflector 450′″ to angularly deflect the laser beam 102 toward a second interface 404 between the optical component 130 and the pedestal 420. The reflector 450′″ may include a wedge-shaped prism that is a temporary component used to facilitate focus of the laser beam 102 at the second interface 404. The reflector 450′″ may include a high index of refraction material. In some examples, the reflector 450′″ may include glass, crystal, or ceramic. The reflector 450′″ is positioned onto the substrate 110 to facilitate welding of components but is not attached to the optical assembly 400′″. The reflector 450′″ includes a reflective surface 452′″, which can be oriented such that the laser beam 102 can enter the reflector 450′″, reflect from a reflective surface 452′″ (e.g., a hypotenuse) of the prism reflector 450′″, such as by total internal reflection and/or a reflective coating disposed on the reflective surface 452′″, and exit the reflector 450′″. In some examples, the reflector 450′″ can be a 45-45-90 prism. Passing the laser beam 102 through the reflector 450′″ may be used to extend the focal length of the laser beam 102. For example, the reflector 450′″ may include a higher index of refraction than surrounding air, and thus extends the focal length of the laser beam 102. Without the reflector 450′″, the laser bean 102 may not reach the second interface 404. In this example, the laser beam 102 is passed through the pedestal 420. Here, the pedestal 420 may be a material that is sufficiently transparent for the wavelength of the laser beam 102. The optical component 130 does not need to pass the laser beam 102, and thus can be either transparent or opaque for the laser beam 102.

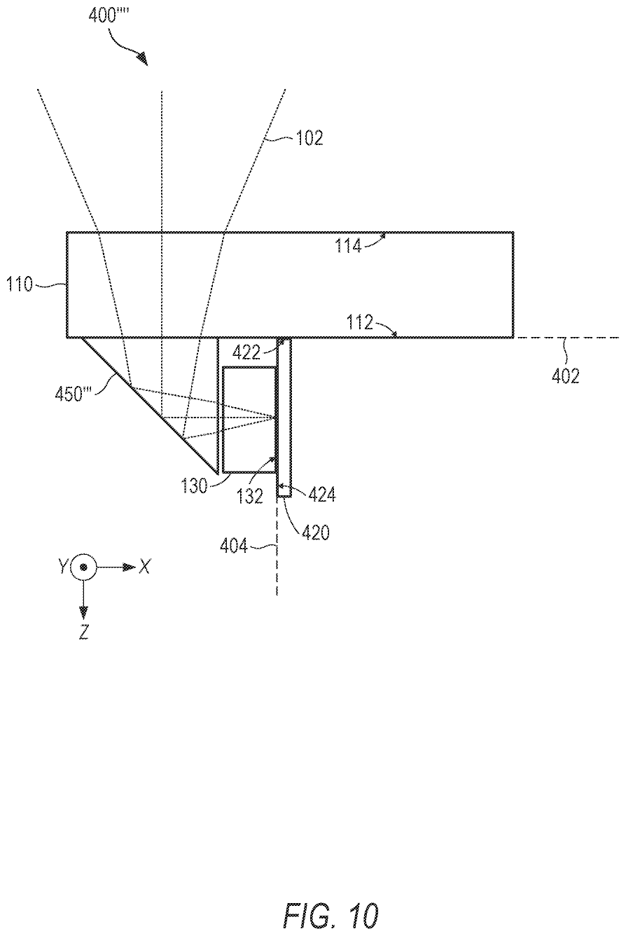

FIG. 10 shows a side view drawing of another example of an optical assembly 400″″ in which the optical component 130 is positionable with five degrees of freedom with respect to the substrate 110. In the optical assembly 400″″, the laser beam 102 reflects from the reflector 450′″. In the configuration shown in FIG. 10, the reflector 450′″ is a 45-45-90 prism, and the laser beam 102 reflects from a hypotenuse of the prism, such as by total internal reflection. Other types of reflectors can also be used. The laser beam 102 passes through the optical component 130 to focus at the second interface 404 between the optical component 130 and the pedestal 420. For this configuration, the optical component 130 can be transparent at the wavelength of the laser beam 102. For this configuration, the pedestal 420 can be transparent at the wavelength of the laser beam 102 or opaque at the wavelength of the laser beam 102.

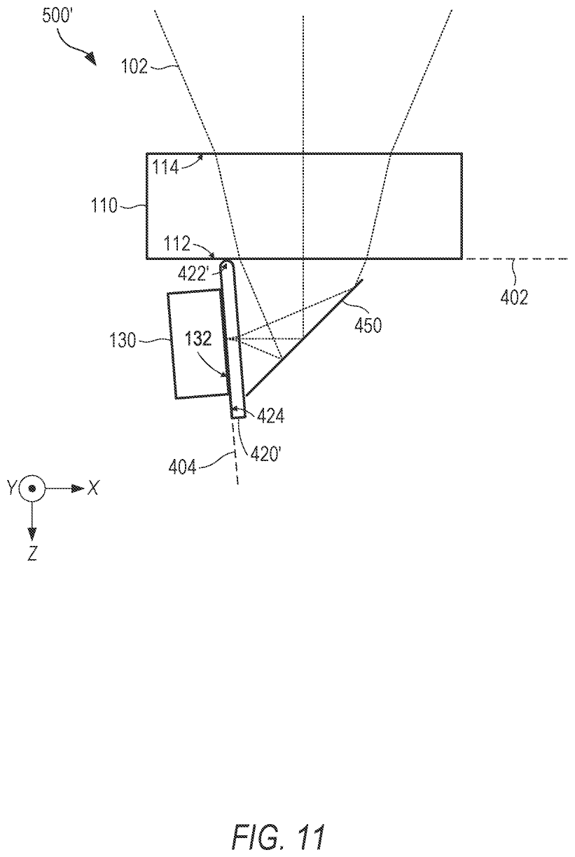

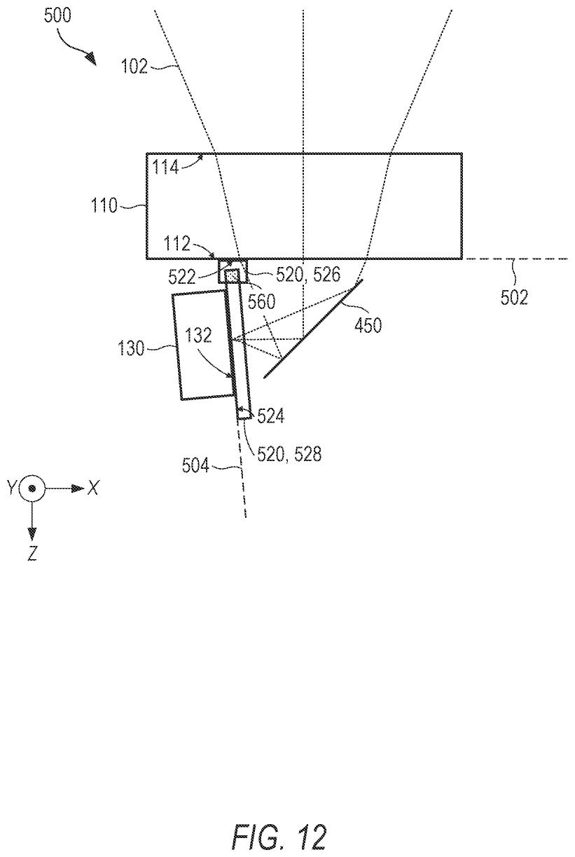

In some embodiments, the pedestal 420 may be tiltable to provide a sixth degree of freedom in the positioning of the optical component 130. FIG. 11 shows a side view drawing of an example of an optical assembly 500′ in which the optical component 130 is positionable with six degrees of freedom with respect to the substrate 110. Specifically, the first planar surface 422′ can be modified to be convex in a cross section that includes the x-z plane in FIG. 11, With such a convex surface, the pedestal 420′ and the optical component 130, together, can be tilted toward or away from the reflector 450 to achieve rotation about they-axis. When the proper-y-axis rotation has been achieved, the pedestal 420′ can be welded to the (e.g., planar) surface 112 of the substrate 110 along a line of contact between the convex surface and the surface 112 of the substrate 110. FIG. 12 below shows an alternate modification of the pedestal 420 in which the pedestal is divided into two elements. The two elements are attachable to each other at different orientations, such as by laser welding over a two-dimensional surface area. Using two elements for the pedestal 420 can provide an additional degree of freedom for the alignment, such as the rotational degree of freedom about they-axis.

FIG. 12 shows a side view drawing of an example of an optical assembly 500 in which the optical component 130 is positionable with six degrees of freedom with respect to the substrate 110. Compared with the optical assembly 400, in which the pedestal 420 is a unitary element, the optical assembly 500 uses a two-piece pedestal 520. By allowing the two pieces of the pedestal to be rotatable in the x-z plane, the two-piece pedestal 520 can achieve rotation around the v-axis.

The optical assembly 500 includes the substrate 110, which is described in detail above. During assembly of the optical assembly 500, the reflector 450 can angularly deflect the laser beam, such as by 90 degrees or about 90 degrees, such that a central axis of the laser beam 102 is parallel or substantially parallel to the surface 112 of the substrate 110. Other deflection angles may also be used.

The optical assembly 500 includes a pedestal 520, which can mechanically support the optical component 130 after the optical assembly 500 has been assembled. In contrast with the unitary (e.g., one-piece) pedestal 420 of FIG. 6, the pedestal 520 of FIG. 12 includes a first pedestal element 526 and a second pedestal element 528 that are attached, such as by laser welding, together along a pedestal interface. In the geometry of FIG. 12, the pedestal interface is parallel to the x-z plane. In the view of FIG. 12, the second pedestal element 528 is closer to the viewer than the first pedestal element 526, such that a portion 560 of the second pedestal element 528 overlaps a portion of the first pedestal element 526. The portion 560 of the second pedestal element 528 and the overlapped portion of the first pedestal element 526 correspond to the region of the pedestal interface.

The pedestal 520 can be attached to the substrate 110, such as by laser welding or some other attachment mechanism. The first pedestal element 526 of the pedestal 520 can have a first (e.g., planar) surface 522 (oriented in the x-Y plane) that faces the substrate 110 and contacts the surface 112 of the substrate 110 at a first interface 502 that extends in the x-y plane. The second pedestal element 528 of the pedestal 520 can have a second (e.g., planar) surface 524 (oriented in the y-z plane) that faces the optical component 130 and contacts the surface 132 of the optical component 130 at a second interface 504 that extends in the Y-z plane. Pedestal elements may be different types of shapes. In some examples, the first pedestal element 526 can be shaped as a cuboid. In some examples, the second pedestal element 528 can be shaped as a cuboid. In some examples, the second pedestal element 528 can be spaced apart from the surface 112 of the substrate 110 (e.g., along the z-axis).

During alignment of the optical component 130 to the substrate 110, the first pedestal element 526, the second pedestal element 528, and the optical component 130, together, are translatable and rotatable in the plane of the first interface 502 to provide three degrees of freedom During alignment of the optical component 130 to the substrate 110, the optical component 130 is translatable and rotatable in the plane of the second interface 504 to provide two additional degrees of freedom. During alignment of the optical component 130 to the substrate 110, the second pedestal element 528 and the optical component 130, together, rotatable in the plane of the pedestal interface (the x-z plane) for an additional degree of freedom about they-axis.

As such, in the configuration of FIG. 12, the optical component 130 can be positioned with respect to the substrate 110 with six degrees of freedom. The six degrees of freedom can include position along the x-axis (by translating the second pedestal element 528 against the first pedestal element 526 along the pedestal interface, or by translating the optical component 130, the first pedestal element 526, and the second pedestal element 528, together, against the substrate 110), position along they-axis (by translating the optical component 130 against the second pedestal element 528, or by translating the optical component 130, the first pedestal element 526, and the second pedestal element 528, together, against the substrate 110), position along the z-axis (by translating the optical component 130 against the second pedestal element 528, or by translating the optical component 130 and the second pedestal element 528, together, against the first pedestal element 526), rotation about the x-axis (by rotating the optical component 130 against the second pedestal element 528), rotation about they-axis (by rotating the optical component 130 and the second pedestal element 528, together, against the first pedestal element 526), and rotation about the z-axis (by rotating the optical component 130, the first pedestal element 526, and the second pedestal element 528, together, against the substrate 110).

When the first pedestal element 526 has been suitably positioned with respect to the substrate 110, the first pedestal element 526 can be affixed to the substrate 110, such as by forming a laser weld at the first interface 502 between the first planar surface 522 of the first pedestal element 526 and the planar surface 112 of the substrate 110, In some examples, the first pedestal element 526 can be attached to the substrate 110 by a mechanism other than laser welding, such as using an adhesive, optical contacting, or others.

When the first pedestal element 526 has been suitably positioned with respect to the second pedestal element 528, the second pedestal element 528 can be laser welded to the first pedestal element 526, such as by forming a laser weld at the pedestal interface (in the x-z plane).

When the optical component 130 has been suitably positioned with respect to the second pedestal element 528, the optical component 130 can be laser welded to the second pedestal element 528, such as by forming a laser weld at the second interface 504 between the planar surface 132 of the optical component 130 and the second planar surface 524 of the second pedestal element 528.

In some examples, the three laser welds can be formed in any suitable order. Some or all of these components may also be attached in ways other than laser welding.

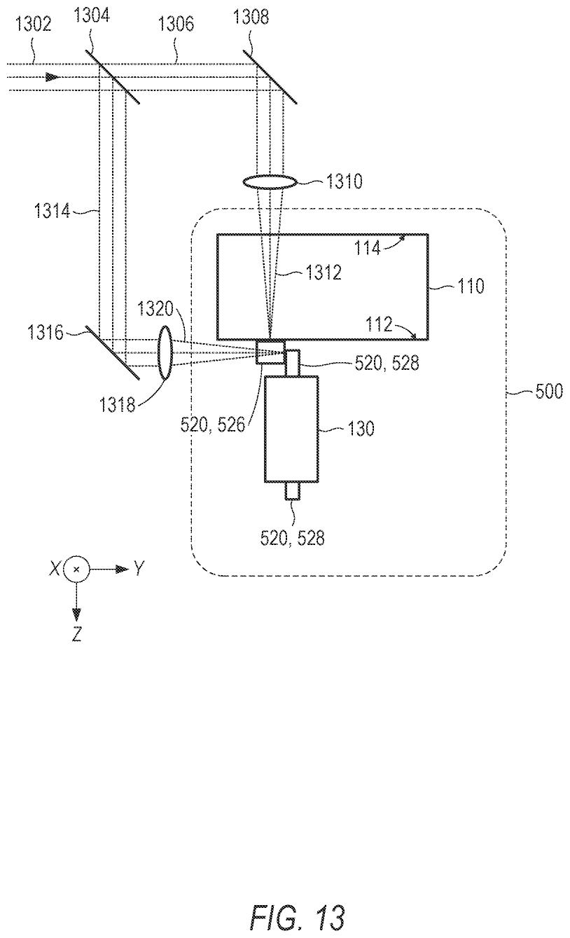

FIG. 13 shows a side view drawing of the optical assembly 500 of FIG. 12, in a view that is orthogonal to that of FIG. 12, with laser welding optics that show how several of the laser welds are formed.

One or more robotic arms (not shown) can position the first pedestal element 526, the second pedestal element 528, and the optical component 130, with respect to the substrate 110. When the robotic arms have suitably positioned the first pedestal element 526, the second pedestal element 528, and the optical component 130, the laser welding optics can direct one or more pulsed laser beams onto an interface between the substrate 110 and the first pedestal element 526, an interface between the first pedestal element 526 and the second pedestal element 528, and an interface between the second pedestal element 528 and the optical component 130.

The positioning and the laser welding can occur in any suitable order. For example, the first pedestal element 526 can be positioned and laser welded to the substrate 110, then the second pedestal element 528 can be positioned and laser welded to the first pedestal element 526, then the optical component 130 can be positioned and laser welded to the second pedestal element 528. In this example, a welding operation can be performed before a next positioning operation. In another example, the first pedestal element 526, the second pedestal element 528, and the optical component 130 can all be positioned with respect to the substrate 110, then the laser welds can occur after the positioning has taken place. Other suitable ordering can also be used. The following discussion details the optical paths traversed by the pulsed laser light to form the welds.

A pulsed light source (not shown) can produce a light beam 1302. In some examples, the light beam 1302 can be collimated. A beamsplitter 1304 can split the light beam 1302 into a first beam 1306 and a second beam 1314.

A first mirror 1308 can direct the first beam 1306 to a first objective lens 1310. The first objective lens 1310 can focus the first beam 1306 to form a converging first beam 1312. In some examples, the converging first beam 1312 can have a central axis that is substantially orthogonal to a plane of the substrate 110. Other suitable orientations can also be used. The converging first beam 1312 can enter the substrate 110 through a second surface 114 of the substrate 110. The second surface 114 of the substrate 110 can be substantially orthogonal to a central axis of the converging first beam 1312, which can help avoid introducing aberrations into the converging first beam 1312 as it passes through the substrate 110. The converging first beam 1312 can pass through the substrate 110. The converging first beam 1312 can come to a focus at the surface 112 opposite the second surface 114, at an interface between the first pedestal element 526 and the substrate 110. At the focus of the converging first beam 1312, the pulsed laser light forms a weld that secures the first pedestal element 526 to the substrate 110.

A second mirror 1316 can direct the second beam 1314 to a second objective lens 1318. The second objective lens 1318 can focus the second beam 1314 to form a converging second beam 1320. In some examples, the converging second beam 1320 can have a central axis that is substantially parallel to a plane of the substrate 110. Other suitable orientations can also be used. In the configuration of FIG. 13, the converging second beam 1320 can pass through an incident surface of the first pedestal element 526, can pass through the first pedestal element 526, and come to a focus at an interface between the first pedestal element 526 and the second pedestal element 528. In an alternate configuration, the converging second beam 1320 can pass through the second pedestal element 528, rather than the first pedestal element 526, to come to the focus at the interface between the first pedestal element 526 and the second pedestal element 528. In some examples, the incident face of the first pedestal element 526 (or the incident face of the second pedestal element 528 in the alternate configuration) can be oriented generally orthogonal to the central axis of the converging second beam 1320 to help avoid introducing aberrations into the converging second beam 1320. At the focus of the converging second beam 1320, the pulsed laser light forms a weld that secures the second pedestal element 528 to the first pedestal element 526.

The weld to attach the optical component 130 to the first pedestal element 526 can be performed with the laser beam 102 as shown in FIG. 12. An additional beamsplitter (not shown in FIG. 13) can direct a portion of the light beam 1302, the first beam 1306, or the second beam 1314 to form the laser beam 102. The laser beam 102 exits an objective lens of the laser welder, passes through the substrate 110 with a central ray of the laser beam 102 being in the z-direction, exits the substrate 110, reflects from the reflector 450 such that the central ray of the reflected laser beam is in the x-direction, passes through the first pedestal element 526, and comes to focus at the second interface 504 between the optical component 130 and the first pedestal element 526.

When the optical component 130 has been attached to the pedestal 520, such as by laser welding, the optical component 130 is spaced apart from the substrate 110. The reflector 450 (FIG. 12) can be removed from the optical assembly 500 after the optical component 130 has been laser welded to second pedestal element 528.

In some examples, the beamsplitter 1304 can be time-invariant, such as a beamsplitter having a fixed transmission/reflection ratio, such as a 50-50 beamsplitter. Other suitable ratios can also be used. For a time-invariant beamsplitter 1304, two or more of the laser welds can be formed simultaneously. In some examples, the beamsplitter 1304 can be time-variant, such as a controllable mirror having a time-varying reflectivity, such as a modulator that can controllably switch between a first state, at which the modulator has a relatively high reflectivity and a relatively low transmissivity, and a second state, at which the modulator has a relatively low reflectivity and a relatively high transmissivity. For a time-variant beamsplitter 1304, two or more of the laser welds can be formed sequentially, such as at different times.

FIG. 14 shows a side view drawing of another example of an optical assembly 500′, with laser welding optics that show how several of the laser welds are formed. The optical assembly of FIG. 14 includes a pedestal 520′ having a single pedestal element (rather than multiple pedestal elements, as shown in FIG. 13.)

One or more robotic arms (not shown) can position the pedestal element 526′ and the optical component 130′ with respect to the substrate 110. When the robotic arms have suitably positioned the pedestal element 526′ and the optical component 130′, the laser welding optics can direct one or more pulsed laser beams onto an interface between the substrate 110 and the pedestal element 526′ and an interface between the pedestal element 526′ and the optical component 130′.

The positioning and the laser welding can occur in any suitable order, for example, in a manner described above with regard to FIG. 13. The light paths in FIG. 14 are similar to those described above with regard to FIG. 13.

When the optical component 130′ has been attached to the pedestal 520′, such as by laser welding, the optical component 130′ can be spaced apart from the substrate 110.

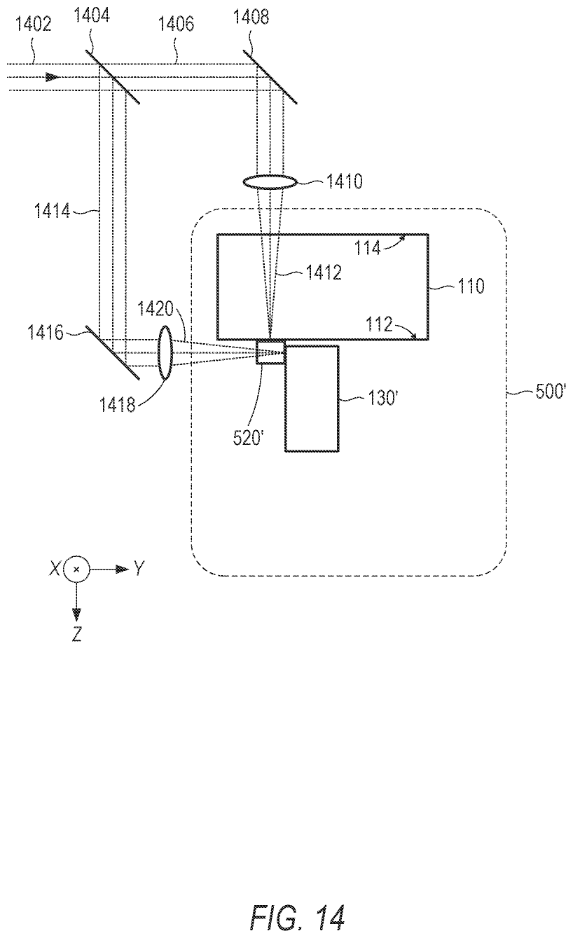

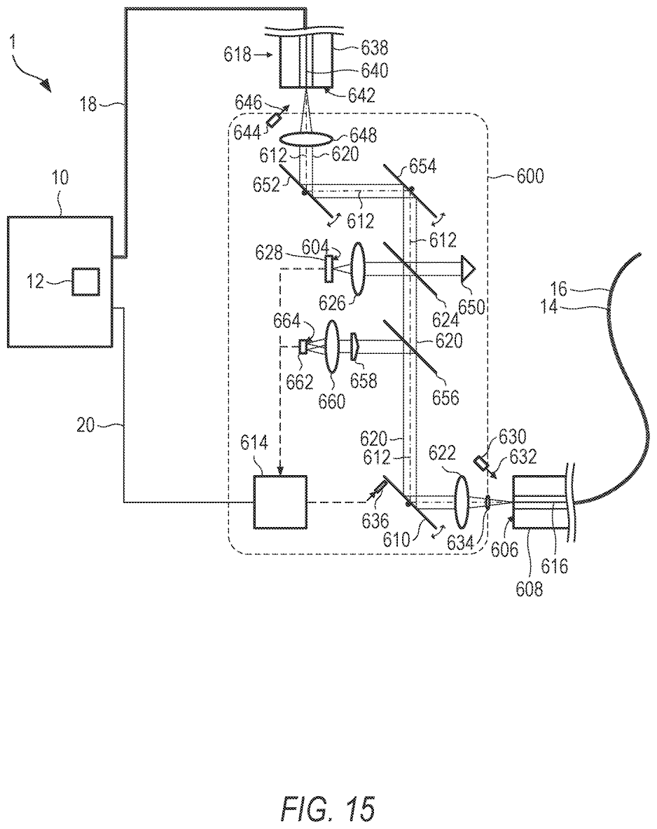

FIG. 15 shows a schematic drawing of an example of an apparatus 1 that includes a system 600 for directing light into an optical fiber. The system 600 can include a variety of optical components that are laser welded to a substrate, using the techniques discussed above. Specifically, any or all of the optical components included within or on the dashed rectangle that encloses the system 600 in FIG. 15 can be attached to a substrate, such as by laser welding, and such as by using a pedestal as described above.

A controller 10 can include various optical and electronic components. For applications directed to shape sensing, such as sensing a three-dimensional orientation or shape of an optical fiber, the controller 10 can include an interrogator 12. The interrogator 12 can direct light into a fiber and analyze light returning from the fiber. The interrogator 12 can use a technique, such as optical frequency domain reflectometry (OFDR), to determine a three-dimensional position of an optical fiber. A catheter 14 can include a sensing optical fiber 16 that extends along at least part of the length of the catheter 14. For clarity, the sensing optical fiber 16 will be referred to in the following discussion as the optical fiber 608. It will be understood that the optical fiber 608 may include the sensing optical fiber 16 or can optionally include a separate portion of fiber coupled to a proximal end of the sensing optical fiber 16. References below to the optical fiber 608 can include one or both of these cases. The controller 10 can include a fiber connection 18, such as a multi-core fiber or a plurality of single-mode fibers, that can provide light as input to the system 600. The controller 10 can include an electrical connection 20, which can provide electrical power to the system 600. A processor 614, which can be located in the controller 10 or located in the system 600, can receive the control signals from the one or more detectors in the system 600 and can drive the one or more actuatable elements in the system 600 to improve the coupling efficiency.

During operation, imaging optics in the system 600 can form an image 604 of an end 606 of the optical fiber 608. An actuatable optical element 610, such as a pivotable mirror, can define an optical path 612 that extends to the actuatable optical element 610 and further extends to the end 606 of the optical fiber 608 when the optical fiber 608 is present. A processor 614 can determine a location in the image 604 of a specified feature in the image 604. The processor 614 can cause, based on the location of the specified feature in the image 604, the actuatable optical element 610 to actuate to align the optical path 612 to a core 616 of the optical fiber 608. During operation of the system 600, a light beam 620 is directed to propagate along the optical path 612 from optical element to optical element, so that the light beam 620 follows the optical path 612.

A light source 618 can direct the light beam 620 along the optical path 612 to couple into a core 616 of the optical fiber 608. For clarity, the fiber in the fiber connection 18 will be referred to in the following discussion as the source optical fiber 638. It will be understood that the source optical fiber 638 may be the same as the fiber connection 18 or can optionally include a separate portion of fiber coupled to a distal end of the fiber connection 18.

For examples in which the optical fiber 608 includes a single core 616, the source optical fiber 638 can include a single core 640. For examples in which the optical fiber 608 includes multiple cores 616, the source optical fiber 638 can also include multiple cores 640. During operation, the system 600 can simultaneously direct light from the multiple cores 640 of the source optical fiber 638 into the multiple cores of the optical fiber 608.

For examples in which the optical fiber 608 includes multiple cores 616, an alternative to receiving light from multiple cores of a multi-core fiber in the fiber connection 18 is receiving light from the cores of a plurality of single-core fibers, such as fibers in a fiber bundle or a linear array of fibers.

In some examples, the processor 614 can cause the actuatable optical element 610 to actuate to align the optical path 612 to the core 616.

The system 600 can optionally further include an illumination light source 630. The illumination light source 630 can illuminate the optical fiber 608 with illumination 632. For configurations that include the illumination light source 630, at least some of the illumination 632 can reflect or scatter from the optical fiber 608 to form first light. An objective element 622 can collimate at least some of the first light to form second light.

A dichroic mirror 624 can direct at least some of the second light away from the optical path 612 to form third light.

A focusing element 626 can focus the third light to form the image 604 at a focal plane of the focusing element 626. An imaging array 628 can be located at the focal plane of the focusing element 626 and can sense the image 604. In some examples, the imaging optics can include the objective element 622, the dichroic mirror 624, the focusing element 626, and the imaging array 628. The processor 614 can receive from the imaging array 628 an analog and/or a digital signal that corresponds to the image 604. Other suitable configurations can also be used.

In the example of FIG. 15, the actuatable optical element 610 is configured as a pivotable mirror. The pivotable mirror can include a reflective mirror that can pivot about a pivot point, and a linear actuator 636 that can pivot the reflective mirror about the pivot point.

The system 600 can optionally further include a field aligning lens 634 located in the optical path 612 proximate the end 606 of the optical fiber 608. Such a field aligning lens 634 can improve the coupling efficiency for cases when the optical fiber 608 is positioned away from a central axis of the optical elements of the system 600 (e.g., off-axis performance).

As an alternative to illuminating the end 642 of the source optical fiber 638, or in addition to performing such illumination, the controller 10 can inject illumination into an opposite end of the source optical fiber 638, which can propagate along the source optical fiber 638 to emerge from the end 642 of the source optical fiber 638.

A second illumination light source 644 can illuminate the source optical fiber 638 with second illumination 646. The second illumination 646 can have a second wavelength that is different from the first wavelength and different from the wavelength of the light beam 620. At least some of the second illumination 646 can reflect or scatter from the source optical fiber 638 to form third light. A source objective element 648, such as a source objective lens or source objective mirror, can collimate at least some of the third light to form fourth light. A dichroic mirror, such as 624, and a reflector 650, such as a retroreflector or retroreflecting prism, can superimpose the second light and the fourth light to form fifth light.

The optical path 612 can include an optional first pivotable element 652 that can redirect the optical path 612 within an angular range that extends in one dimension or in two dimensions. The optical path 612 can include an optional second pivotable element 654 that can redirect the optical path 612 within an angular range that extends in one dimension or in two dimensions.

The beamsplitter 656 can receive light that has been reflected and/or scattered from the end 606 of the optical fiber 608. The beamsplitter 656 can direct a portion of the reflected light toward a bi-prism 658, a lens 660, and a sensor 662. The lens 660 can focus the light emergent from the bi-prism 658 to form an image 664 at the sensor 662.

The bi-prism 658 can impart a wedge angle between opposing halves of the reflected light such that the specified feature, such as the circumferential edge of the optical fiber 608) in the image 664 has a corresponding duplicate feature in the image 664. The processor 614 can further determine, based at least in part on a spacing between the specified feature and the corresponding duplicate feature, the longitudinal separation between the focus and the end 606 of the optical fiber 608. For these configurations, the spacing can be considered to be a focus error signal. The spacing can be compared against a specified distance, which can be determined in an initial configuration of the system 600, such as at a factory during initial assembly and alignment of the system 600. If the spacing is less than the specified distance, the focus can be on one side of the end 606 of the optical fiber 608, such as outside the optical fiber 608. If the spacing is greater than the specified distance, the focus can be on the other side of the end 606 of the optical fiber 608, such as within the optical fiber 608.

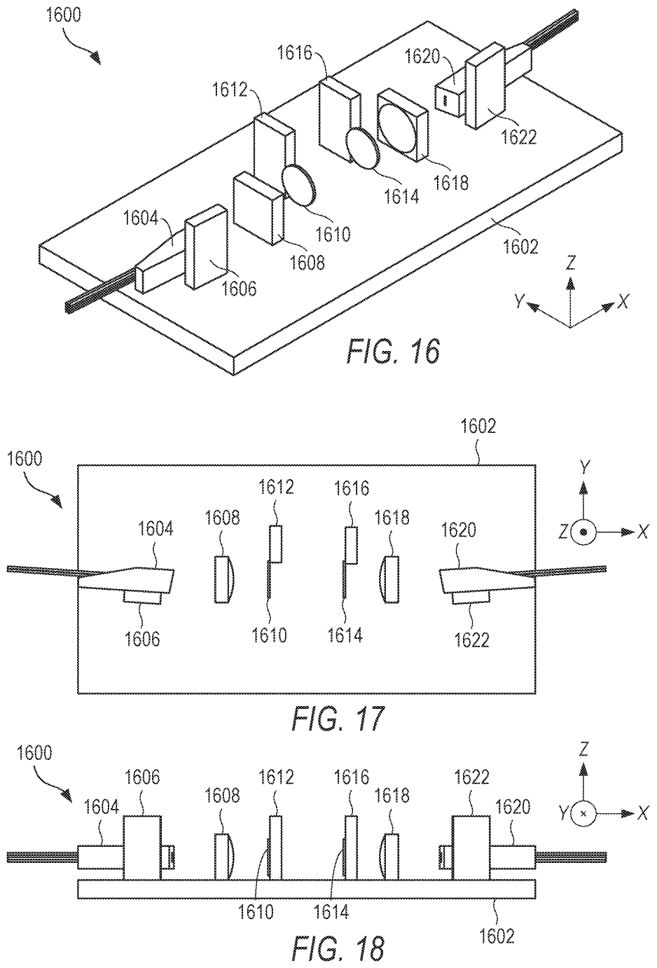

FIG. 16 shows a plan view of an example of an optical assembly 1600. FG. 17 shows a top view of the optical assembly 1600 of FIG. 16. FIG. 18 shows a side view of the optical assembly 1600 of FIG. 16. The optical assembly 1600 can include a substrate 1602. The optical assembly 1600 can include optical components that can receive light and/or transmit light to other optical components, such as via free space coupling.

The optical assembly 1600 can include a first fiber ribbon array 1604. In some examples, the first fiber ribbon array 1604 can include eight fibers arranged linearly. Other numbers of fibers and other arrangements can also be used. The first fiber ribbon array 1604 can be attached to a pedestal 1606, such as by laser welding. The pedestal 1606 can be attached to the substrate 1602, such as by laser welding.

The optical assembly 1600 can include a first lens 1608. In some examples, the first lens 1608 can include a square or rectangular perimeter, in which adjacent sides of the perimeter are orthogonal or substantially orthogonal. The first lens 1608 can be attached directly to the substrate 1602, such as by laser welding a side of the perimeter to the substrate 1602. In other configurations, the first lens 1608 can optionally be attached to a pedestal, which in turn can be attached to the substrate 1602, such as by laser welding.

The optical assembly 1600 can include a polarizer 1610. The polarizer 1610 can be attached to a pedestal 1612, such as by laser welding. The pedestal 1612 can be attached to the substrate 1602, such as by laser welding.

The optical assembly 1600 can include a wave plate 1614. The wave plate 1614 can be attached to a pedestal 1616, such as by laser welding. The pedestal 1616 can be attached to the substrate 1602, such as by laser welding.

The optical assembly 1600 can include a second lens 1618. In some examples, the second lens 1618 can include a square or rectangular perimeter, in which adjacent sides of the perimeter are orthogonal or substantially orthogonal. The second lens 1618 can be attached directly to the substrate 1602, such as by laser welding a side of the perimeter to the substrate 1602. In other configurations, the second lens 1618 can optionally be attached to a pedestal, which in turn can be attached to the substrate 1602, such as by laser welding.

The optical assembly 1600 can include a second fiber ribbon array 1620. In some examples, the second fiber ribbon array 1620 can include eight fibers arranged linearly. Other numbers of fibers and other arrangements can also be used. The second fiber ribbon array 1620 can be attached to a pedestal 1622, such as by laser welding. The pedestal 1622 can be attached to the substrate 1602, such as by laser welding.

During alignment and assembly of the optical assembly 1600, and via the use of pedestals 1606 and 1622, the first fiber ribbon array 1604 can be placed at a focal point of the first lens 1608, and the second fiber ribbon array 1620 can be placed at a focal point of the second lens 1618.

In some examples, the fibers in the fiber ribbon array 1604 and the second fiber ribbon array 1620 can have their respective ends cleaved at an angle, rather than orthogonal to the fiber, to reduce or prevent reflections from the tip from propagating back along the fiber. Such angled cleaving can direct light exiting the fiber at an angle with respect to a longitudinal axis of the fiber. As such, the orientations of both the fiber ribbon array 1604 and the second fiber ribbon array 1620 are angled with respect to a central axis of the optical assembly 1600, such as an axis that passes through a center of the first lens 1608 and a center of the lens 1618.

The polarizer 1610 and the wave plate 1614 may have relatively loose placement tolerances, such as along the x-axis, the y-axis, and the z-axis, but relatively tight rotation tolerances (e.g., in the y-z plane to ensure proper alignment with light that propagates along a longitudinal x-axis that extends from the first fiber ribbon array 1604 to the second fiber ribbon array 1620). The polarizer 1610 and the wave plate 1614 may be first positioned to have a desired rotational position, then laser welded to respective pedestals 1612 and 1616. The pedestals 1612 and 1616 then may be attached to the substrate 1602.

In some examples, a pedestal can mechanically support a relatively thin optical element, such as a filter, polarizer, or wave plate that has a relatively large clear aperture or diameter and a relatively small thickness. As such, the pedestal allows for edge mounting of thin optical components, which may or may not have z-height separation from the substrate. In some examples, an optical component may have a thickness that is less than a thickness of an edge of a pedestal that is attached to the substrate. For example, the thickness of a thin optical component that uses pedestal support for attachment to the substrate may be between about 0.1 mm and about 0.5 mm. The aspect ratio of the optical components may also be factor in the use of the pedestal. For example, for an optical component having a diameter of 0.25 mm, a thickness between 0.1 mm to 0.5 mm may be sufficiently thick for direct substrate attachment. However, for an optical component having a diameter of 15 mm, a thickness of up to about 0.75 mm may be too thin for direct substrate attachment and thus require use of a pedestal.

In some examples, such as the configuration of FIGS. 16-18, the laser welds may be located outside a clear aperture of the respective optical components, such that the laser welds are located away from the light beams that traverse the optical system. In other examples, one or more laser welds may be located within a clear aperture of the respective optical components, such that light beams pass through the laser welds. Using fused silica (or another suitable non-polarizing material) for the pedestal can allow the pedestal to be located in the path of the beam.

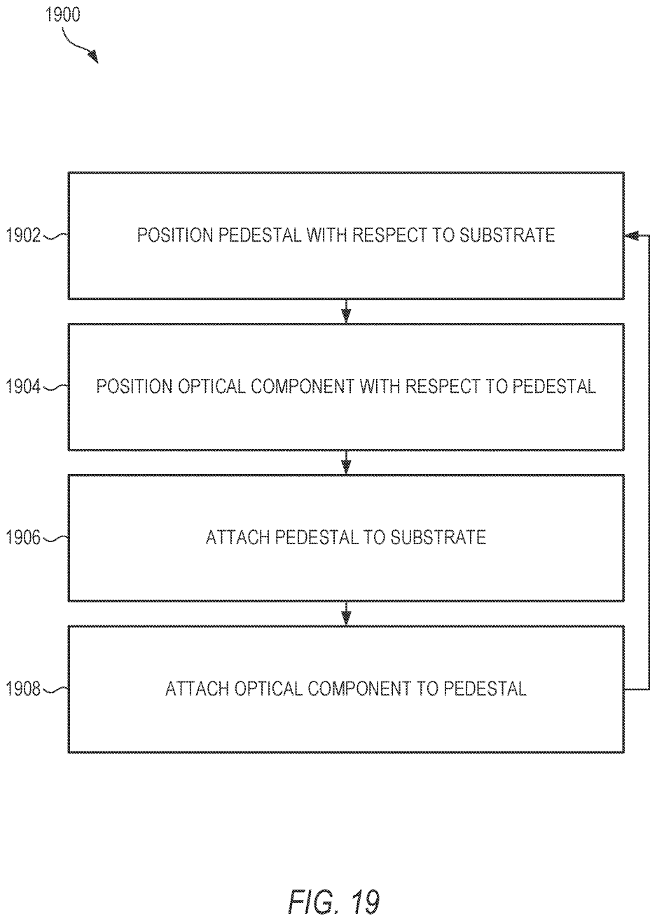

FIG. 19 shows a flow chart of an example of a method 1900 for generating an optical assembly. The method 1900 can be executed to generate any or all of the optical assemblies shown in FIG. 1-14, or other suitable optical assemblies. The method 1900 is but one example of a method for generating an optical assembly; other suitable methods can also be used. The method 1900 may include additional or fewer operations. The operations may be performed in different orders.

At operation 1902, the method 1900 can position a pedestal, such as pedestal 140A, pedestal 140B, pedestal 240, pedestal 340, pedestal 420, or pedestal 520, with respect to a substrate, such as substrate 110. In some examples, the method 1900 can use one or more robotic arms to hold, manipulate, and/or position the pedestal. In general, the effectiveness of laser welding decreases as spacing between the components increases. For example, positioning two surfaces of adjacent components together such that a gap between the surfaces is less than a few microns can help avoid weld failure, such as formation of cracks in one or both components.

At operation 1904, the method 1900 can position an optical component, such as optical component 130, optical component 130A, or optical component 13011, with respect to the pedestal. In some examples, the method 1900 can use one or more robotic arms to hold, manipulate, and/or position the optical component.

At operation 1906, the method 1900 can attach the pedestal to the substrate. In some examples, the method 1900 can use laser welding to attach the pedestal to the substrate. In some examples, the laser welding can attach the pedestal to the substrate without an attachment material. For these examples, a direct laser welding can be used where the laser melts the material of the pedestal and/or substrate to create the attachment. The bonds between the pedestal and the substrate are formed from material of the pedestal and/or substrate melted via the laser welding.

At operation 1908, the method 1900 can attach the optical component to the pedestal. In some examples, the method 1900 can use laser welding to attach the optical component to the pedestal. The optical component can be spaced apart from the substrate. In some examples, the laser welding can attach the pedestal to the optical component without an attachment material. For these examples, a direct laser welding can be used where the laser melts the material of the pedestal and/or the optical component to create the attachment. The bonds between the pedestal and the optical component are formed from material of the pedestal and/or optical component melted via the laser welding.

In some examples, the direct laser welding can be performed using an ultra-fast pulse laser. For these examples, the laser pulses can deliver large amounts of energy in a small area quickly such that the component material can absorb the wavelength of laser light. As such, there is no need to use an adhesive material that absorbs light between adjacent components to create the bonding. Furthermore, the use of ultra-fast pulse laser can help reduce or eliminate cracking of the component material. It is noted that other attachment techniques may also be used in combination with the direct laser welding to attach the pedestal to the optical components (e.g., in locations that don't have the laser welding), including the use of adhesives or other attachment material.

In some examples, operation 1906 can be performed before operation 1908. In some examples, operation 1908 can be performed before operation 1906.

The method 1900 may be repeated to attach multiple optical components to the substrate.

In some examples, multiple instances of the method 1900 can be executed in parallel to attach multiple optical components to the substrate in parallel.

In some examples, the pedestal, such as pedestal 140A, pedestal 140B, pedestal 240, pedestal 340, or pedestal 420, can be unitary.

In other examples, the pedestal, such as pedestal 520, can be a multi-piece pedestal. For example, the pedestal, such as pedestal 520, can include a first pedestal element, such as first pedestal element 526, and a second pedestal element, such as second pedestal element 528. For multi-piece pedestals, the method 1900 can optionally further include laser welding the first pedestal element to the substrate, laser welding the second pedestal element to the first pedestal element.

In some examples, such as the optical assembly 300 of FIG. 5, laser welding the optical component to the pedestal can include passing a laser beam, such as laser beam 102, through the pedestal, such as pedestal 340. The laser beam can be reflected within the pedestal, such as pedestal 340.

In some examples, such as the optical assembly 400 of FIG. 6 or the optical assembly 500 of FIG. 12, for configurations in which the reflector 450 includes a prism and the reflection is an internal reflection from the hypotenuse of the prism, laser welding the optical component to the pedestal can include positioning a reflector, such as reflector 450, on the substrate, such as substrate 110, and passing a laser beam, such as laser beam 102, through the reflector and the pedestal, such as pedestal 420 or pedestal 520. The laser beam can be reflected within the reflector toward the pedestal.

In some examples, such as the optical assembly 400 of FIG. 6 or the optical assembly 500 of FIG. 12, for configurations in which the reflector 450 includes a front-surface mirror or a prism for which the reflection is an external reflection from the hypotenuse of the prism, laser welding the optical component to the pedestal can include positioning a reflector, such as reflector 450, on the substrate, such as substrate 110, reflecting a laser beam, such as laser beam 102, from the reflector without passing the laser beam through the reflector, and passing the reflected laser beam through the pedestal.

In some examples, such as the optical assembly 400 of FIG. 6 or the optical assembly 500 of FIG. 12, the method 1900 can optionally further include separating a laser beam, such as laser beam 102, into a first beam and a second beam. Attaching the pedestal, such as pedestal 420 or pedestal 520, to the substrate, such as substrate 110, can include passing the first beam through the substrate. Laser welding the optical component, such as optical component 130, to the pedestal can include passing the second beam through the pedestal.

In Some examples, laser welding the optical component to the pedestal can include holding the optical component in place with respect to the pedestal using a robotic arm. Other suitable assembly techniques can also be used.

In the description, specific details have been set forth describing some examples. Numerous specific details are set forth to provide a thorough understanding of the examples. It will be apparent, however, to one skilled in the art that some examples may be practiced without some or all of these specific details. The specific examples disclosed herein are meant to be illustrative but not limiting. One skilled in the art may realize other elements that, although not specifically described here, are within the scope of this disclosure.

Any alterations and further modifications to the described assemblies, apparatuses, methods, and any further application of the principles of the present disclosure are fully contemplated as would normally occur to one skilled in the art to which the disclosure relates. To avoid needless descriptive repetition, one or more components or actions described in accordance with one illustrative example can be used or omitted as applicable from other illustrative examples. For the sake of brevity, the numerous iterations of these combinations will not be described separately. For simplicity, in some instances the same reference numbers are used throughout the drawings to refer to the same or like parts.

Additionally, one or more elements in examples of this disclosure, including operations of methods, may be implemented in software to execute on a processor of a computer system such as a control processing system. When implemented in software, the elements of the examples of the present disclosure are essentially the code segments to perform the necessary tasks. The program or code segments can be stored in a processor readable storage medium (e.g., a non-transitory storage medium) or device that may have been downloaded by way of a computer data signal embodied in a carrier wave over a transmission medium or a communication link. The processor readable storage device may include any medium that can store information including an optical medium, semiconductor medium, and magnetic medium. Processor readable storage device examples include an electronic circuit, a semiconductor device, a semiconductor memory device, a read only memory (ROM), a flash memory, an erasable programmable read only memory (EPROM); a floppy diskette, a CD-ROM, an optical disk, a hard disk, or other storage device. The code segments may be downloaded via computer networks such as the Internet, Intranet, etc. Any of a wide variety of centralized or distributed data processing architectures may be employed. Programmed instructions may be implemented as a number of separate programs or subroutines, or they may be integrated into a number of other aspects of the systems described herein. In some examples, the control system may support wireless communication protocols such as Bluetooth, Infrared Data Association (IrDA), HomeRF, IEEE 802.11, Digital Enhanced Cordless Telecommunications (DECT), ultra-wideband (UWB), ZigBee, and Wireless Telemetry.

While certain example examples of the present disclosure have been described and shown in the accompanying drawings, it is to be understood that such examples are merely illustrative of and not restrictive to the broad disclosed concepts, and that the examples of the present disclosure not be limited to the specific constructions and arrangements shown and described, since various other modifications may occur to those ordinarily skilled in the art.

1. An optical assembly, comprising:
a substrate;
a wedge-shaped first pedestal having a first pedestal surface laser welded to the substrate, a second pedestal surface that is orthogonal to the first pedestal surface, and a third pedestal surface that is angled with respect to the first pedestal surface; and
a first optical component laser welded to the second pedestal surface of the first pedestal.

2. The optical assembly of claim 1, wherein the first optical component is directly laser welded to the second pedestal surface of the first pedestal without using an adhesive material.

3. The optical assembly of claim 1, wherein a bond between the first optical component and the first pedestal is formed from material of at least one of the first optical component and the first pedestal melted via laser welding.

4. The optical assembly of claim 1, wherein the first optical component is spaced apart from the substrate.

5. (canceled)

6. The optical assembly of claim 1, further comprising:
a second pedestal attached to the substrate; and
a second optical component laser welded to the second pedestal and spaced apart from the substrate, the first optical component being positioned to receive light from the second optical component or transmit light to the second optical component.

7. The optical assembly of claim 1, further comprising:
a second optical component laser welded to the substrate, the first optical component being positioned to receive light from the second optical component or transmit light to the second optical component.

8. The optical assembly of claim 1, wherein the first optical component, the first pedestal, and the substrate each include at least one of glass, crystal, or ceramic.

9-12. (canceled)

13. The optical assembly of claim 1, wherein the first pedestal has a higher index of refraction than the substrate.

14-15. (canceled)

16. The optical assembly of claim 1, wherein the first optical element is one of:
an objective element configured to collimate the light;
an actuatable optical element configured to define an optical path for the light;
a dichroic mirror configured to direct a first portion of the light in a first direction and a second portion of the light in a second direction; and
a focusing element configured to focus the light to form an image at a focal plane of the focusing element.

17. The optical assembly of claim 1, wherein the first pedestal includes at least one of a metal or silicon.

18-24. (canceled)

25. A method for generating an optical assembly the method comprising:
attaching a first pedestal surface of a wedge-shaped pedestal to a substrate, the pedestal having a second pedestal surface orthogonal to the first pedestal surface and a third pedestal surface angled with respect to the first pedestal surface; and
laser welding an optical component to the second pedestal surface of the pedestal using an ultra-fast laser.

26. The method of claim 25, wherein the optical component is directly laser welded to the second pedestal surface of the pedestal without using an adhesive material between the optical component and the pedestal.

27. The method of claim 25, wherein laser welding the optical component to the second pedestal surface of the pedestal includes melting material of at least one of the optical component and the pedestal to form a bond between the first optical component and the pedestal.

28. The method of claim 25, wherein laser welding the optical component to the second pedestal surface of the pedestal includes:
passing a laser beam through the substrate and the first pedestal surface of the pedestal, the laser beam being totally internally reflected within the pedestal at the third pedestal surface and thereby directed toward the optical component and focused at an interface between the optical component and the second pedestal surface.

29. The method of claim 28, wherein the third pedestal surface is angled at 45 degrees with respect to the first pedestal surface, and wherein the laser beam, after reflection at the third pedestal surface, passed through the pedestal parallel to the first pedestal surface.

30. (canceled)

31. The method of claim 25, wherein attaching the first pedestal surface of the pedestal to the substrate includes laser welding the first pedestal surface to the substrate.

32. (canceled)

33. The method of claim 31, wherein laser welding the first pedestal surface to the substrates includes passing a laser beam through the substrate and focusing the laser beam at an interface between the substrate and the pedestal.

34. (canceled)

35. The method of claim 25, wherein:
the method further comprises separating a laser beam into a first beam and a second beam;
laser welding the first pedestal surface of the pedestal to the substrate includes passing the first beam through the substrate and focusing the first beam at an interface between the substrate and the pedestal; and
laser welding the optical component to the second pedestal surface of the pedestal includes passing the second beam through the substrate and the first pedestal surface of the pedestal, totally internally reflecting the second beam within the pedestal at the third pedestal surface and thereby directing the second beam toward the optical component and focusing the second beam at an interface between the optical component and the second pedestal surface.

36. The method of claim 25, wherein laser welding the optical component to the third pedestal surface of the pedestal includes holding the optical component in place with respect to the pedestal using a robotic arm, the optical component being spaced apart from the substrate.

37. The method of claim 25, further comprising:
prior to attaching the first pedestal surface of the pedestal to the substrate and laser welding the optical component to the third pedestal surface of the pedestal, aligning the optical component to the substrate by:
translating and rotating the pedestal in a plane of the first pedestal surface with respect to the substrate; and
translating and rotating the optical component in a plane of the third pedestal surface with respect to the pedestal.
